(19) United States
(12) Patent Application Publication
(10) Pub. No.: US 2026/0212030 A1
(43) Pub. Date: Jul. 23, 2026

(54) DIGITAL TOKEN TO FACILITATE DISTRIBUTED COMPUTING ENVIRONMENT PROCESSING OF DATASET

(71) Applicant: INTERNATIONAL BUSINESS MACHINES CORPORATION, Armonk, NY (US)

(72) Inventors: Al CHAKRA, Apex, NC (US); Leonard James CARCARAMO, JR., Kingston, NY (US); John BOUZAKIS, Wappingers Falls, NY (US); Elpida TZORTZATOS, Lagrangeville, NY (US)

(21) Appl. No.: 19/026,826

(22) Filed: Jan. 17, 2025

(51) Int. Cl. G06F 21/60

(52) U.S. Cl. CPC G06F 21/604

(57) ABSTRACT

Dataset processing with a distributed computing environment, which includes one or more distributed computing services, is facilitated by a process which includes generating a digital token for the dataset, where the generating includes incorporating decision-making logic into the digital token to facilitate dataset processing within the distributed computing environment, and generating one or more levels of metadata for the dataset related to processing of the dataset within the distributed computing environment, using the decision-making logic, and incorporating the one or more levels of metadata into the digital token. Further, the process includes linking the digital token to the dataset to facilitate control of processing of the dataset within the distributed computing environment, and transmitting the dataset to the distributed computing environment for processing using, at least in part, the decision-making logic and the one or more levels of metadata of the digital token.

### BACKGROUND

One or more aspects relate, in general, to processing of a dataset within a distributed computing environment, and more particularly, to improved dataset processing control within a trusted distributed computing environment with one or more distributed computing services.

By way of example, in a distributed machine learning environment, a variety of types of datasets can be used. For instance, a dataset can be a training dataset for a machine learning model, such as where a machine learning algorithm processes data to derive patterns and/or relationships to facilitate making predictions on new datasets. In addition, a dataset for a machine learning environment can be provided for use in other ways. For instance, the dataset can contain historical data for use in predictive modeling, or to train a classification model, or can be applied against a classification model, used in image recognition, or to train an image recognition model, etc. Additionally, datasets can be used in validation and testing of a machine learning model to, for instance, validate a model's performance. Many dataset use variations are possible within a variety of distributed computing environments, including a variety of distributed machine learning environments.

### SUMMARY

Certain shortcomings of the prior art are overcome, and additional advantages are provided herein through the provision of a method which includes generating a digital token for a dataset to be processed by a distributed computing environment, which includes a distributed computing service. The generating of the digital token includes incorporating decision-making logic into the digital token to facilitate dataset processing within the distributed computing environment, and generating one or more levels of metadata for the dataset related to processing of the dataset within the distributed computing environment using the decision-making logic, and incorporating the one or more levels of metadata into the digital token. In addition, the method includes linking the digital token to the dataset to facilitate control of processing of the dataset within the distributed computing environment, including by the distributed computing service, and transmitting the dataset to the distributed computing environment for processing using, at least in part, the decision-making logic and the one or more levels of metadata of the digital token.

In another aspect, a method is provided which includes generating a digital token for a dataset to be processed by a trusted machine learning environment which includes one or more distributed machine learning services. The generating of the digital token includes incorporating decision-making logic into the digital token to facilitate dataset processing within the trusted machine learning environment, and to control how the dataset traverses the trusted machine learning environment during processing, including how the dataset traverses a distributed machine learning service of the one or more distributed machine learning services. In addition, the generating of the digital token linked to the dataset includes generating multiple levels of metadata for the dataset related to processing of the dataset within the trusted machine learning environment using the decision-making logic, and incorporating the multiple levels of metadata into the digital token. The multiple levels of metadata include one or more of an immutable metadata level, a clone mutable metadata level, an append only metadata level, and a mutable metadata level for the dataset related to processing of the dataset within the trusted machine learning environment. In addition, the method includes linking the digital token with the dataset to facilitate control of processing of the dataset within the trusted machine learning environment, and transmitting the dataset to the trusted machine learning environment for processing using, at least in part, the decision-making logic and the multiple levels of metadata of the digital token.

In a further aspect, a method is provided which includes receiving, by a distributed computing environment with one or more distributed computing services, a dataset and a digital token linked to the dataset for processing within the distributed computing environment. The digital token includes decision-making logic to facilitate processing of the dataset within the distributed computing environment, and one or more levels of metadata for the dataset related to processing of the dataset within the distributed computing environment. In addition, the method includes processing the dataset within the distributed computing environment using, at least in part, the decision-making logic and the one or more levels of metadata of the received digital token linked to the dataset.

Computer program products and computer systems relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the disclosed inventive aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present disclosure;

FIGS. 2A-2B depict embodiments of a computer program product with token code, in accordance with one or more aspects of the present disclosure;

FIGS. 3A-3B depict embodiments of a token process workflow, in accordance with one or more aspects of the present disclosure;

FIGS. 4A-4D depict another example of a computing environment to include and/or use one or more aspects of the present disclosure;

FIG. 5 depicts a further example of a computing environment to include and/or use one or more aspects of the present disclosure;

FIG. 6 depicts one example of a machine learning model training service, in accordance with one or more aspects of the present disclosure;

FIGS. 7A-7D depict one detailed embodiment of digital token and distributed computing environment processing, in accordance with one or more aspects of the present disclosure; and

FIGS. 8A-8B depict a further embodiment of digital token and distributed computing environment processing, in accordance with one or more aspects of the present disclosure.

### DETAILED DESCRIPTION

In general, one or more aspects of the present disclosure relate to data sovereignty, process auditing, artificial intelligence or machine learning explainability, and data processing integrity. In accordance with one or more aspects of the present disclosure, a capability is provided to facilitate processing within a computing environment, and more particularly, to facilitate dataset processing within a distributed computing environment or ecosystem. In addition, in accordance with one or more aspects of the present disclosure, a capability is provided to improve control of processing of a dataset within a distributed computing environment which includes one or more distributed computing services. For instance, in one or more embodiments, the distributed computing environment is, or includes, a trusted machine learning environment, and the one or more distributed computing services are, and/or include, one or more distributed machine learning services.

In one or more aspects, the capabilities are facilitated by generating a digital token for a dataset to be processed within a distributed computing environment, where the digital token includes decision-making logic to facilitate dataset processing within the distributed computing environment, and includes one or more levels of metadata for the dataset related to processing of the dataset within the distributed computing environment using the decision-making logic. As described herein, the digital token is linked to the dataset to facilitate control of processing of the dataset within the distributed computing environment, including by one or more distributed computing services of the distributed computing environment. In one or more embodiments, the distributed computing environment is a trusted distributed computing environment. Note also that processing of the dataset described herein refers to processing of the dataset using, for instance, one or both of the decision-making logic and the one or more levels of metadata in processing the dataset within the distributed computing environment, including, by one or more distributed computing services of the environment.

Provided herein, in one or more aspects, is a method which includes generating a digital token for a dataset to be processed by a distributed computing environment, where the distributed computing environment includes a distributed computing service. The generating of the digital token includes incorporating decision-making logic into the digital token to facilitate dataset processing within the distributed computing environment. Further, generating the digital token includes generating one or more levels of metadata for the dataset related to processing of the dataset within the distributed computing environment using the decision-making logic, and incorporating the one or more levels of metadata into the digital token. Further, the method includes linking the digital token to the dataset to facilitate control of processing of the dataset within the distributed computing environment, including by the distributed computing service, and transmitting the dataset to the distributed computing environment for processing, at least in part, using the decision-making logic, and the one or more levels of metadata, of the digital token. Advantageously, the method improves processing of a dataset within a distributed computing environment, and more particularly, improves control of dataset processing within a distributed computing environment that includes a distributed computing service. Further, the method facilitates control by a dataset owning entity of how and where a dataset is processed within a distributed computing environment, including how it is processed through a distributed computing service.

Additionally, or alternatively, in one or more embodiments, the decision-making logic of the digital token directs how, with reference to the one or more levels of metadata, the dataset is to traverse the distributed computing service of the distributed computing environment during processing. Advantageously, the digital token provides a dataset owning entity with control over how and/or where the dataset traverses or is processed within the distributed computing service of the distributed computing environment.

Additionally, or alternatively, in one or more embodiments, incorporating the decision-making logic into the digital token further includes incorporating decision-making logic into the digital token to control when a status report call is executed during processing of the dataset within the distributed computing environment, and wherein executing the status report call references, at least in part, the one or more levels of metadata incorporated into the digital token in sending a status report from the distributed computing environment to an identified computing system identified via the digital token. Incorporating decision-making logic into the digital token to control when a status report call is executed during processing of a dataset within the distributed computing environment facilitates auditing the distributed computing environment processing of the dataset by a dataset owning entity.

Additionally, or alternatively, in one or more embodiments, generating the one or more levels of metadata includes generating one or more of an immutable metadata level, a clone mutable metadata level, an append only metadata level and a mutable metadata level, and linking the digital token to the dataset occurs prior to transmitting the dataset and digital token to the distributed computing environment. By generating the one or more levels of metadata to include one or more of an immutable metadata level, a clone mutable metadata level, an append only metadata level and a mutable metadata level, the method provides a dataset owning entity (for instance) significant control over how the dataset is processed by the distributed computing environment, including how and when status reports are provided, such as for monitoring.

Additionally, or alternatively, in one or more embodiments, generating the digital token for the dataset further includes generating multiple levels of metadata for the dataset related to processing of the dataset within the distributed computing environment using the decision-making logic, and incorporating the multiple levels of metadata into the digital token, the multiple levels of metadata including the one or more levels of metadata. Advantageously, generating the multiple levels of metadata for the dataset related to processing of the dataset within the distributed computing environment further allows a dataset owning entity to customize control over processing of the dataset within the distributed computing environment, including by the distributed computing service.

Additionally, or alternatively, in one or more embodiments, generating the multiple levels of metadata includes generating an immutable metadata level for the dataset. The immutable metadata level includes one or more of dataset owning entity information, service level agreement (SLA) requirements for the dataset, privacy requirements for the dataset, confidentiality requirements for the dataset, export control requirements for the dataset, and notification criteria for the dataset when processed within the distributed computing environment, including by the distributed computing service. Advantageously, the method facilitates compliance with dataset related requirements by ensuring that the dataset transmitted to the distributed computing environment, including to the distributed computing service, is linked with an immutable metadata level which ensures that the dataset is processed by, and traverses, the distributed computing environment based on the provided decision-making logic and metadata requirements. For instance, the method advantageously ensures that the distributed computing environment can be exploited according to the dataset service level agreement (SLA) requirements, while the processing also remains compliant with all other specified requirements of the immutable metadata level.

Additionally, or alternatively, in one or more embodiments, generating the multiple levels of metadata includes generating a clone mutable metadata level for the dataset indicating that a token ID of the digital token is clone mutable during processing of the dataset within the distributed computing environment. Advantageously, incorporating the clone mutable metadata level into the digital token facilitates decision-making logic splitting of the dataset during processing into two or more disparate datasets, each with a clone digital token and a respective clone token ID.

Additionally, or alternatively, in one or more embodiments, generating the multiple levels of metadata includes generating an append only metadata level for the dataset to indicate that one or more of: an error occurring during processing of the dataset within the distributed computing environment is to be appended to the metadata, and pedigree information is to be appended to the metadata during processing of the dataset within the distributed computing environment. Advantageously, the append only metadata data level of the digital token facilitates tracking of errors occurring during processing of the dataset, and retrieval of pedigree information to, for instance, enable the pedigree of a distributed computing service and/or recommendation or prediction of a distributed computing service to be created based on how the corresponding dataset is processed and how the dataset traverses the distributed computing environment, including the distributed computing service.

Additionally, or alternatively, in one or more embodiments, generating the multiple levels of metadata further includes generating a mutable metadata level for the dataset. The mutable metadata level is generated to hold at least one of current location data of the dataset when being processed within the distributed computing environment, and classification data for the dataset when being processed within the distributed computing environment. Advantageously, generating the mutable metadata level for the dataset relates to monitoring processing of the dataset within the distributed computing environment and incorporating the mutable metadata level into the digital token facilitates retrieval via, for instance, a status report call, of current location data of the dataset and/or a classification of the dataset when being processed within the distributed computing environment.

Additionally, or alternatively, in one or more embodiments, generating the multiple levels of metadata includes generating the multiple levels of metadata from the group consisting of an immutable metadata level, a clone mutable metadata level, an append only metadata level and a mutable metadata level for the dataset related to processing of the dataset within the distributed computing environment. Advantageously, generating the multiple levels of metadata from the group consisting of an immutable metadata level, a clone mutable metadata level, an append only metadata level and a mutable metadata level for the dataset related to processing of the dataset within the distributed computing environment allows a dataset owning entity enhanced control over how and where the dataset is processed within the distributed computing environment, as well as enhanced control over splitting of the dataset, and monitoring of the dataset when being processed within the distributed computing environment.

Additionally, or alternatively, in one or more embodiments, generating the one or more levels of metadata for the dataset includes generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment. Advantageously, the method facilitates splitting of the dataset during processing within the distributed computing environment and ensuring that the digital token linked to the dataset is cloned and associated with the disparate datasets resulting from splitting of the dataset.

Additionally, or alternatively, in one or more embodiments, incorporating the decision-making logic into the digital token includes incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token. Advantageously, the method facilitates splitting of the dataset during processing of the decision-making logic within the distributed computing environment and ensures that the digital token linked to the dataset is cloned and associated with the disparate datasets resulting from splitting of the dataset.

In accordance with one or more aspects, each of the above-noted embodiments is separable and optional from one another. Further, the above-noted embodiments can be combined with one another. In one or more embodiments the distributed computing environment is, and/or includes, a machine learning environment and the distributed computing service is, and/or includes, a distributed machine learning service.

In one or more other aspects, a computer program product is provided. The computer program product includes one or more computer-readable storage media and program instruction stored on the one or more computer-readable storage media to perform operations. The operations include generating a digital token for a dataset to be processed by a distributed computing environment, where the distributed computing environment includes a distributed computing service. The generating of the digital token includes incorporating decision-making logic into the digital token to facilitate the dataset processing within the distributed computing environment, including by the distributed computing service. Further, generating the digital token linked to the dataset includes generating one or more levels of metadata for the dataset related to processing of the dataset within the distributed computing environment using the decision-making logic, and incorporating the one or more levels of metadata into the digital token. In addition, the operations include linking the digital token to the dataset to facilitate control of processing of the dataset within the distributed computing environment, including by the distributed computing service, and transmitting the dataset to the distributed computing environment for processing using, at least in part, the decision-making logic, and the one or more levels of metadata, of the digital token. Advantageously, the computer program product improves processing of a dataset within a distributed computing environment, and more particularly, improves control of dataset processing within a distributed computing environment that includes a distributed computing service. Further, the method facilitates control by a dataset owning entity of how and where the dataset is processed within the distributed computing environment, including how it is processed through the distributed computing service.

Additionally, or alternatively, in one or more computer program product embodiments, the decision-making logic of the digital token directs how, with reference to the one or more levels of metadata, the dataset traverses the distributed computing service of the one or more distributed computing environment during processing. In one or more computer program product embodiments, generating the levels of metadata further includes generating one or more of an immutable metadata level, a clone mutable metadata level, an append only metadata level and a mutable metadata level for the dataset related to processing of the dataset within the distributed computing environment. Advantageously, the digital token provides a dataset owning entity with control over how the dataset traverses or is processed within the distributed computing service of the distributed computing environment. By generating the one or more levels of metadata to include one or more of an immutable metadata level, a clone mutable metadata level, an append only metadata level and a mutable metadata level, the operations provide a dataset owning entity significant control over how the dataset is processed within the distributed computing environment, including, for instance, how and when status reports are provided for improved monitoring of the dataset.

Additionally, or alternatively, in one or more computer program product embodiments, incorporating the decision-making logic into the digital token further includes incorporating decision-making logic into the digital token to control when a status report call is executed during processing of the dataset within the distributed computing environment, where executing the status report call references, at least in part, the one or more levels of metadata incorporated into the digital token in sending a status report from the distributed computing environment to an identified computing system identified via the digital token. In one or more computer program product embodiments, generating the one or more levels of metadata includes generating one or more of an immutable metadata level, a clone mutable metadata level, an append only metadata level and a mutable metadata level for the dataset related to processing of the dataset within the distributed computing environment. Incorporating decision-making logic into the digital token to control when a status report call is executed during processing a dataset within the distributed computing environment facilitates auditing of the distributed computing environment processing of the dataset.

Additionally, or alternatively, in one or more computer program product embodiments, generating of the digital token linked to the dataset further includes generating multiple levels of metadata for the dataset related to processing of the dataset within the distributed computing environment using the decision-making logic, and incorporating the multiple levels of metadata into the digital token, where the multiple levels of metadata include the one or more levels of metadata, and wherein generating the multiple levels of metadata includes generating the multiple levels of metadata from the group consisting of an immutable metadata level, a clone mutable metadata level, an append only metadata level and a mutable metadata level for the dataset related to processing of the dataset within the distributed computing environment. Advantageously, generating the multiple levels of metadata from the group consisting of an immutable metadata level, a clone mutable metadata level, an append only metadata level and a mutable metadata level for the dataset related to processing of the dataset within the distributed computing environment allows (for instance) a dataset owning entity enhanced influence over how and where the dataset is processed within the distributed computing environment, as well as enhanced control over splitting of the dataset, and monitoring of the dataset when being processed within the distributed computing environment.

Additionally, or alternatively, in one or more computer program product embodiments, generating the one or more levels of metadata for the dataset includes generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment, and wherein incorporating the decision-making logic into the digital token includes incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token. Advantageously, the method facilitates splitting of the dataset during processing within the distributed computing environment and ensuring that the digital token linked to the dataset is cloned and associated with the disparate datasets resulting from splitting of the dataset.

In accordance with one or more aspects, each of the above-noted computer program product embodiments is separable and optional from one another. Further, the above-noted computer program product embodiments can be combined with one another. In one or more embodiments the distributed computing environment is, and/or includes, a machine learning environment and the distributed computing service is, and/or includes, a distributed machine learning service.

In one or more further aspects, a computer system is provided which includes a processor set, one or more computer-readable storage media, and program instructions stored on the one or more computer-readable storage media to cause the processor set to perform operations. The operations include generating a digital token for a dataset to be processed by a distributed computing environment, where the distributed computing environment includes a distributed computing service. Generating the digital token for the dataset includes incorporating decision-making logic into the digital token to facilitate dataset processing within the distributed computing environment and generating one or more levels of metadata for the dataset related to processing of the dataset within the distributed computing environment using the decision-making logic, and incorporating the one or more levels of metadata into the digital token. Further, the operations include linking the digital token with the dataset to facilitate control of processing of the dataset within the distributed computing environment, including by the distributed computing service, and transmitting the dataset to the distributed computing environment for processing using, at least in part, the decision-making logic, and the one or more levels of metadata, of the digital token. Advantageously, the method improves processing of a dataset within a distributed computing environment, and more particularly, improves control of dataset processing within a distributed computing environment that includes a distributed computing service. Further, the method facilitates control by a dataset owning entity of how and where a dataset is processed within a distributed computing environment, including how it is processed through a distributed computing service.

Additionally, or alternatively, in one or more computer system embodiments, the decision-making logic of the digital token directs, with reference to the one or more levels of metadata, traversal of the dataset through the distributed computing service of the distributed computing environment during processing. In one or more computer system embodiments, generating the levels of metadata includes generating one or more of an immutable metadata level, a clone mutable metadata level, an append only metadata level and a mutable metadata level for the dataset related to processing of the dataset within the distributed computing environment. Advantageously, the digital token provides a dataset owning entity with control over how the dataset traverses and/or is processed through the distributed computing service of the distributed computing environment. By generating the one or more levels of metadata to include one or more of an immutable metadata level, a clone mutable metadata level, an append only metadata level and a mutable metadata level, the computer system provides a dataset owning entity (for instance) significant control over how the dataset is processed within the distributed computing environment, including, for instance, how and when status reports are provided.

Additionally, or alternatively, in one or more computer system embodiments, generating the one or more levels of metadata for the dataset includes generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment, and wherein incorporating the decision-making logic into the digital token comprises incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token. Advantageously, the process facilitates splitting of the dataset during processing within the distributed computing environment and ensuring that the digital token linked to the dataset is cloned and associated with the disparate datasets resulting from splitting of the dataset.

In accordance with one or more aspects, each of the above-noted computer system embodiments is separable and optional from one another. Further, the above-noted computer system embodiments can be combined with one another. In one or more embodiments the distributed computing environment is, and/or includes, a machine learning environment and the distributed computing service is, and/or includes, a distributed machine learning service.

In one or more other aspects, a method is provided which includes generating a digital token for a dataset to be processed by a trusted machine learning environment which includes one or more distributed machine learning services. Generating the digital token for the dataset includes incorporating decision-making logic into the digital token to facilitate dataset processing within the trusted machine learning environment, and to control how the dataset traverses the machine learning environment during processing, including how the dataset traverses a distributed machine learning service of the one or more distributed machine learning services. In addition, generating the digital token for the dataset for the trusted machine learning environment includes generating multiple levels of metadata for the dataset related to processing of the dataset within the trusted machine learning environment using the decision-making logic, and incorporating the multiple levels of metadata into the digital token, where the multiple levels of metadata include one or more of an immutable metadata level, a clone mutable metadata level, an append only metadata level, and a mutable metadata level for the dataset related to processing of the dataset within the trusted machine learning environment. Further, the method includes linking the digital token to the dataset to facilitate control of processing of the dataset within the trusted machine learning environment, and transmitting the dataset to the trusted machine learning environment for processing using, at least in part, the decision-making logic and the multiple levels of metadata of the digital token. Advantageously, the method improves processing of a dataset within a trusted machine learning environment, and more particularly, improves control of dataset processing within a trusted machine learning environment that includes a distributed machine learning service. Further, the method facilitates control by a dataset owning entity of how and where the dataset is processed within the trusted machine learning environment, including how it is traversed through the distributed machine learning service.

Additionally, or alternatively, in one or more method embodiments, incorporating the decision-making logic into the digital token further includes incorporating decision-making logic into the digital token to control when a status report call is executed during processing of the dataset within the trusted machine learning environment, where executing the status report call references, at least in part, the one or more levels of metadata of the multiple levels of metadata incorporated into the digital token in sending a status report from the trusted machine learning environment to an identified computing system identified via the digital token. Incorporating decision-making logic into the digital token to control when a status report call is executed during processing a dataset within the trusted machine learning environment facilitates auditing of the trusted machine learning environment processing of the dataset by controlling when a status report call is executed during processing of the dataset within the trusted machine learning environment to send a status report from the trusted machine learning environment to the identified computing system.

Additionally, or alternatively, in one or more method embodiments, generating the one or more levels of metadata for the dataset includes generating a clone mutable metadata level indicating that a token ID of the digital token is clone mutable, and incorporating the clone mutable metadata level into the digital token to facilitate splitting of the dataset and cloning of the digital token during processing of the dataset within the trusted machine learning environment, where incorporating the decision-making logic into the digital token includes incorporating decision-making logic to spilt the dataset during processing within the trusted machine learning environment into disparate datasets, each with a clone of the digital token, and to assign a new unique token ID to each clone digital token and associated disparate dataset, pursuant to the token ID being clone mutable in the clone mutable metadata level incorporated within the digital token. Advantageously, the method facilitates splitting of the dataset during processing within the trusted machine learning environment and ensuring that the digital token linked to the dataset is cloned and associated with the disparate datasets resulting from splitting of the dataset.

In accordance with one or more aspects, each of the above-noted methods is separable and optional from one another. Further, the above-noted method embodiments can be combined with one another.

In accordance with one or more further aspects, a method is provided which includes receiving, by a distributed computing environment with one or more distributed computing services, a dataset and a digital token linked to the dataset for processing within the distributed computing environment. The digital token includes decision-making logic to facilitate processing of the dataset within the distributed computing environment including by the one or more distributed computing services, and one or more levels of metadata for the dataset related to processing of the dataset within the distributed computing environment. In one or more embodiments, the method further includes processing the dataset within the distributed computing environment using, at least in part, the decision-making logic and the one or more levels of metadata of the received digital token linked to the dataset. Advantageously, the method improves processing of a dataset within a distributed computing environment, and more particularly, improves control of dataset processing within a distributed computing environment that includes a distributed computing service. Further, the method facilitates control by, for instance, a dataset owning entity of how and where the dataset is processed within the distributed computing environment, including how it is processed through the distributed computing service.

Additionally, or alternatively, in one or more method embodiments, the decision-making logic of the digital token directs, with reference to the one or more levels of metadata, traversal of the dataset through a distributed computing service of the one or more distributed computing services during processing of the dataset within the distributed computing environment. Advantageously, the digital token provides a dataset owning entity with control over how the dataset traverses or is processed by the distributed computing service of the distributed computing environment.

In accordance with one or more aspects, each of the above-noted methods is separable and optional from one another. Further, the above-noted method embodiments can be combined with one another. In one or more embodiments, the distributed computing environment is, and/or includes, a machine learning environment and the distributed computing service is, and/or includes, a distributed machine learning service.

In accordance with one or more aspects, a method is provided which includes generating a digital token for a dataset to be processed by a distributed computing environment, where the distributed computing environment includes a distributed computing service. The generating of the digital token includes incorporating decision-making logic into the digital token to facilitate dataset processing within the distributed computing environment. Further, generating the digital token includes generating one or more levels of metadata for the dataset related to processing of the dataset within the distributed computing environment using the decision-making logic, and incorporating the one or more levels of metadata into the digital token. Further, the method includes linking the digital token to the dataset to facilitate control of processing of the dataset within the distributed computing environment, including by the distributed computing service, and transmitting the dataset to the distributed computing environment for processing, at least in part, using the decision-making logic, and the one or more levels of metadata, of the digital token. In one or more embodiments, the decision-making logic of the digital token directs, with reference to the one or more levels of metadata, traversal of the dataset through the distributed computing service of the distributed computing environment during processing. Further, in one or more embodiments, generating the digital token for the dataset further includes generating multiple levels of metadata for the dataset related to processing of the dataset within the distributed computing environment using the decision-making logic, and incorporating the multiple levels metadata into the digital token, where the multiple levels of metadata include the one or more levels of metadata. Advantageously, the method improves control of processing of a dataset within a distributed computing environment, and more particularly, improves control of dataset processing within a distributed computing environment that includes a distributed computing service. The digital token provides a dataset owning entity with control over how and/or where the dataset traverses or is processed by the distributed computing service of the distributed computing environment. Further, generating the multiple levels of metadata for the dataset related to processing of the dataset within the distributed computing environment further allows a dataset entity to customize control over processing of the dataset with the distributed computing environment, including by the distributed computing service. In addition, in one or more further embodiments, the distributed computing environment can be, and/or include, a machine learning environment and the distributed computing service can be, and/or include, a distributed machine learning service.

In accordance with one or more aspects, a method is provided which includes generating a digital token for a dataset to be processed by a distributed computing environment, where the distributed computing environment includes a distributed computing service. The generating of the digital token includes incorporating decision-making logic into the digital token to facilitate dataset processing within the distributed computing environment. Further, generating the digital token includes generating one or more levels of metadata for the dataset related to processing of the dataset within the distributed computing environment using the decision-making logic, and incorporating the one or more levels of metadata into the digital token. Further, the method includes linking the digital token to the dataset to facilitate control of processing of the dataset within the distributed computing environment, including by the distributed computing service, and transmitting the dataset to the distributed computing environment for processing, at least in part, using the decision-making logic, and the one or more levels of metadata, of the digital token. In one or more embodiments, the decision-making logic of the digital token directs, with reference to the one or more levels of metadata, traversal of the dataset through the distributed computing service of the distributed computing environment during processing. Further, in one or more embodiments, generating the digital token for the dataset includes generating multiple levels of metadata for the dataset related to processing of the dataset within the distributed computing environment using the decision-making logic, and incorporating the multiple levels metadata into the digital token, there the multiple levels of metadata include the one or more levels of metadata. In one or more embodiments, generating the multiple levels of metadata for the dataset includes generating a clone mutable metadata level indicting that a token ID of the digital token is clone mutable, and incorporating the clone mutable metadata level into the digital token to facilitate splitting of the dataset in clone the digital token during processing of the dataset within the distributed computing environment. Further, in one or more embodiments, incorporating the decision-making logic into the digital token includes incorporating decision-making logic to split the digital token during processing within the distributed computing environment into disparate datasets, with a clone of the digital token, and to assign a new unique token ID to each clone digital token and associated disparate dataset, pursuant to the token ID being clone mutable and the clone mutable metadata level being incorporated into the digital token. In one or more embodiments, the distributed computing environment can be, and/or include, a machine learning environment and the distributed computing service can be, and/or include, a distributed machine learning service. Advantageously, the method improves processing of a dataset within a distributed computing environment, and more particularly, improves control of dataset processing within a distributed computing environment that includes a distributed computing service. The digital token provides a dataset owning entity with control over how and/or where the dataset traverses or is processed by the distributed computing service of the distributed computing environment. Further, generating the multiple levels of metadata for the dataset related to processing of the dataset within the distributed computing environment further allows a dataset entity to customize control over processing of the dataset with the distributed computing environment, including by the distributed computing service. Advantageously, the method further facilitates splitting of the dataset during processing within the distributed computing environment and ensures that the digital token linked to the dataset is cloned and associated with a disparate dataset resulting from the splitting of the dataset. Further, the method facilitates splitting of the dataset during processing within the distributed computing environment and ensures that the digital token linked to the dataset is cloned and associated with the disparate datasets resulting from splitting of the dataset. Where the distributed computing environment is, and/or includes, a machine learning environment and the distributed computing service is, and/or includes, a distributed machine learning service, the method advantageously improves processing of a dataset within the machine learning environment, and more particularly, improves control of dataset processing within the machine learning environment. In one or more embodiments, the method facilitates control by a dataset owning entity of how and where a dataset is processed within a machine learning environment, including how it is processed through a distributed machine learning service.

Methods, computer program products and computer systems relating to one or more aspects are described and claimed herein. Each of the embodiments of the methods can be embodiments of a computer program product and/or a computer system, and vice versa. Further, each of the embodiments are separable and optional from one another. Moreover, embodiments can be combined with one another. Each of the method embodiments can be combined with aspects and/or embodiments of one or more of the computer program products and/or computer systems, and vice versa.

Aspects of the present disclosure and certain features, advantages, and details thereof, are explained more fully below with reference to the non-limiting example(s) illustrated in the accompanying drawings. Descriptions of well-known software, systems, devices, processing techniques, tools, etc., are omitted so as not to unnecessarily obscure the disclosure in detail. It should be understood, however, that the detailed description and the specific example(s), while indicating aspects of the disclosure, are given by way of illustration only, and are not by way of limitation. Various substitutions, modifications, additions, and/or arrangements, within the spirit and/or scope of the underlying inventive concepts will be apparent to those skilled in the art for this disclosure. Note further that reference is made below to the drawings, where the same or similar reference numbers used throughout different figures designate the same or similar components. Also, note that numerous inventive aspects and features are disclosed herein, and unless otherwise inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, systems, or tools only as examples, and not by way of limitation. Furthermore, the illustrative embodiments are described in certain instances using particular software, hardware, tools, and/or data processing environments only as example for clarity of description. The illustrative embodiments can be used in conjunction with other comparable or similarly purposed structures, systems, applications, architectures, tools, engines, etc. One or more aspects of an illustrative embodiment can be implemented in software, hardware, or a combination thereof.

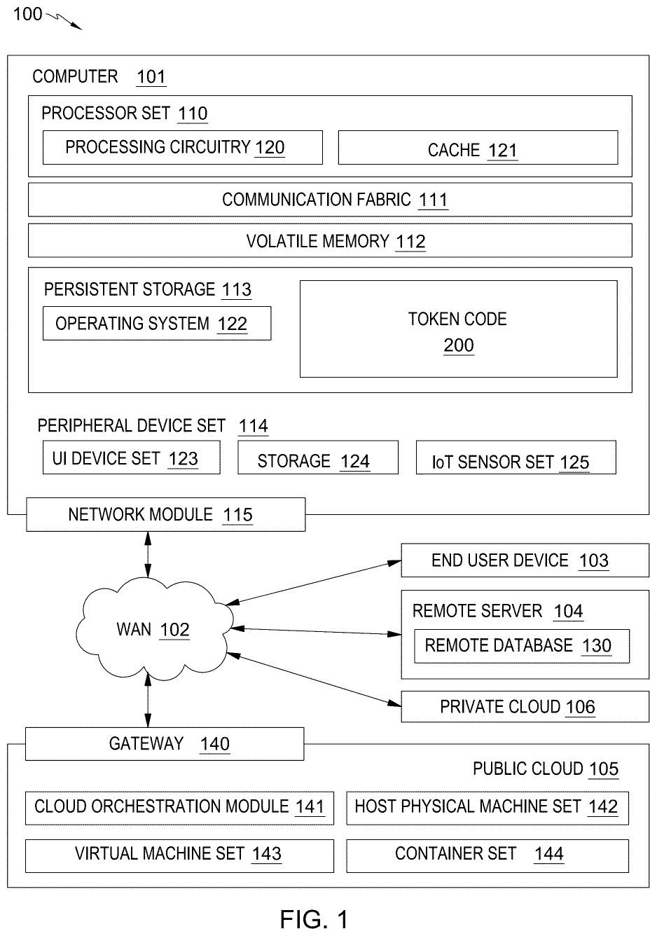

As understood by one skilled in the art, program code, as referred to in this application, can include software and/or hardware. For example, program code in certain embodiments of the present disclosure can utilize a software-based implementation of the functions described, while other embodiments can include fixed function hardware. Certain embodiments combine both types of program code. Examples of program code, also referred to as code, or one or more programs, are depicted in FIG. 1, including operating system 122 and token code 200, which are stored in persistent storage 113.

One or more aspects of the present disclosure are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one or more processor sets, each with one processor or multiple processors, and/or any other type of environment and/or configuration, etc., that is capable of executing a process (or multiple processes) that, e.g., perform processing, such as disclosed herein. Aspects of the present disclosure are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As illustrated in FIG. 1, computing environment 100 contains an example of an environment for the execution of at least some of the computer code involved in performing the inventive methods, such as token code 200. In addition to code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in token code 200 includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above is only one example of a computing environment to incorporate, perform and/or use one or more aspects of the present disclosure. Other examples are possible. Further, in one or more embodiments, one or more of the components/modules of FIG. 1 need not be included in the computing environment and/or are not used for one or more aspects of the present disclosure. Further, in one or more embodiments, additional and/or other components/modules can be used. Other variations are possible.

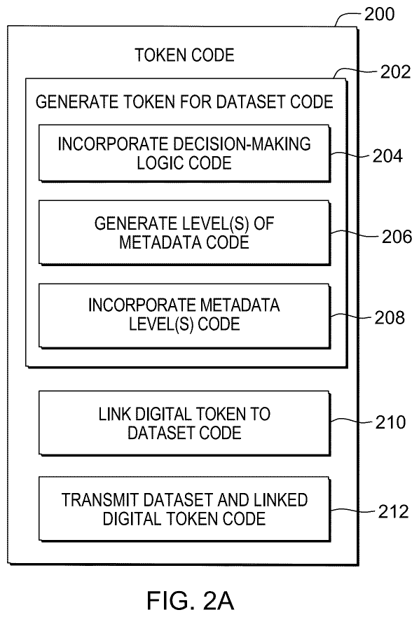

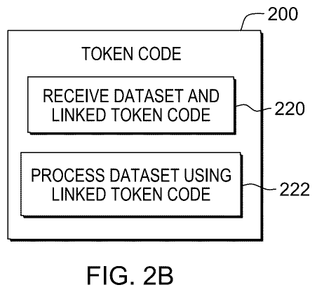

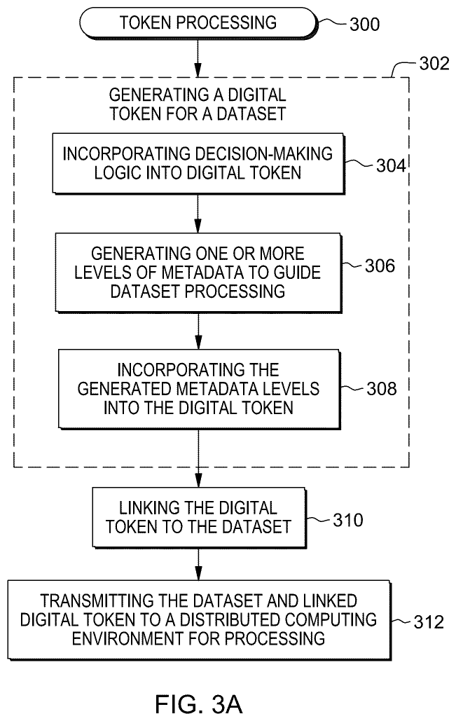

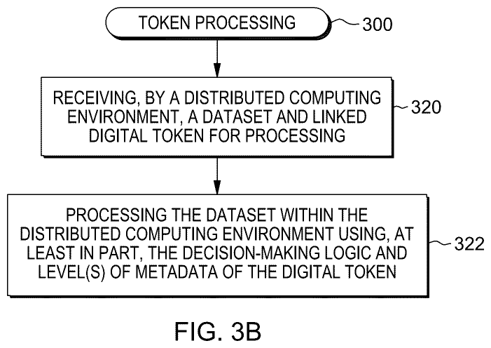

By way of example, embodiments of token code and token workflows are described initially with reference to FIGS. 2A-3B. FIGS. 2A-2B depict embodiments of token code 200 that include code or instruction to perform token processing, in accordance with one or more aspects of the present disclosure, and FIGS. 3A-3B depict embodiments of token process workflows, in accordance with one or more aspects of present disclosure.

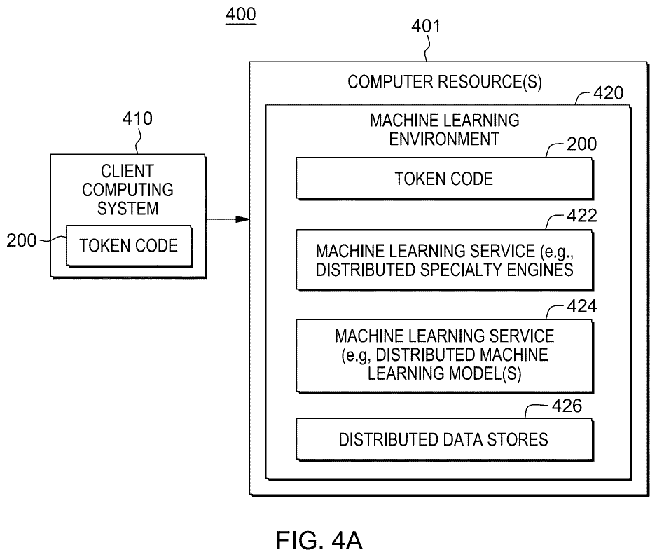

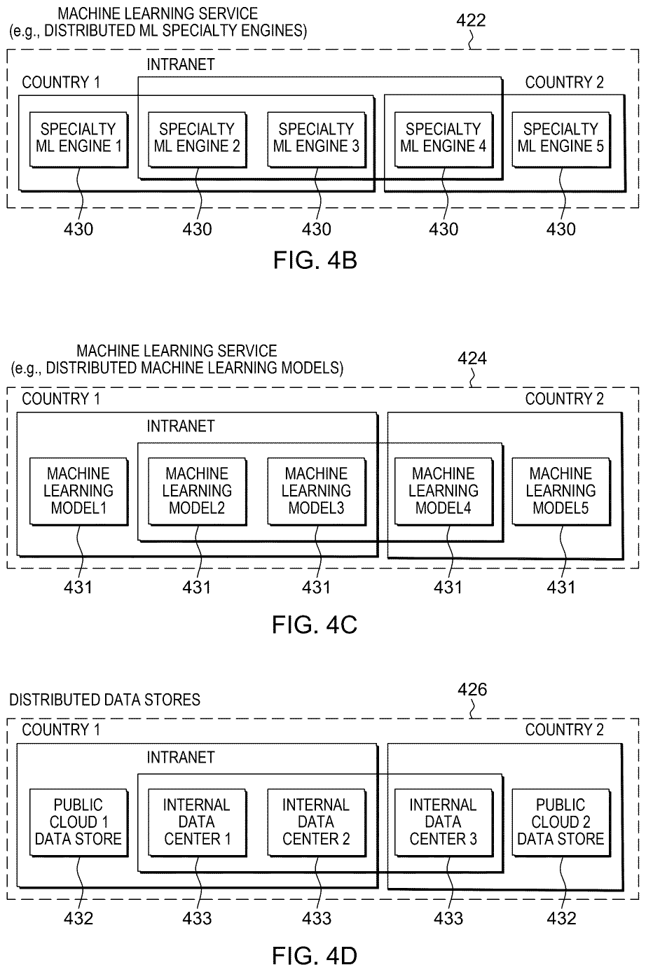

Referring to FIGS. 1-2B, token code 200 includes, in one example, various code or sub-modules used to perform processing, in accordance with one or more aspects of present disclosure. The sub-modules are, e.g., computer-readable program code (e.g., instructions) in computer-readable media (e.g. persistent storage 113, such as a disk) and/or cache (e.g., cache 121) as examples). The computer-readable media can be part of one or more computer program products and can be executed by and/or using one or more computers, such as computer(s) 101 (FIG. 1), computing system 410 (FIG. 4A) and/or machine learning environment 420 (FIG. 4A), etc.; one or more processor sets 110 (FIG. 1); processors, such as one or more processors of processor set 110; and/or processing circuitry, such as processing circuitry of processor set 110, etc.

As noted, FIG. 2A-2B depict embodiments of token code 200 which, in one or more implementations, uses, includes, and/or facilitates, generating a digital token linked to a dataset to facilitate distributed computing environment processing of the dataset, in accordance with one or more aspects of present disclosure. As depicted in FIG. 2A, in one or more embodiments, token code 200 includes generate token for dataset code 202 to generate a digital token for a dataset for processing within a distributed computing environment. Note that as used herein “dataset” includes any type data (such as input data, intermediate data, and/or output data) and/or instructions (e.g., machine learning (ML) model program code, code to initiate training a ML model, etc.) to be processed within a specified distributed computing environment, such as a trusted, distributed computing environment. In one or more embodiments, the distributed computing environment includes one or more distributed computing services. Further, in one or more embodiments, the distributed computing environment is/or includes a machine learning environment. In one or more embodiments, the machine learning environment includes a distributed computing environment or ecosystem incorporating one or more distributed computing services. In one or more embodiments, the distributed computing environment can be a trusted environment predefined by, for instance, an entity owning the dataset to be processed.

The distributed computing environment (e.g., machine learning environment) is adapted, in one or more embodiments, to follow a protocol where the one or more distributed computing services (e.g., one or more distributed machine learning services) are participants in and compliant with the protocol. For instance, in one or more embodiments, once a distributed computing service has completed processing, the protocol can instruct the service to pass control of processing to the decision-making logic incorporated within the digital token associated with the dataset. The decision-making logic then executes and decides how next to process the dataset. In such a manner, process control can be automatically handed off between one or more distributed computing services of the distributed computing environment and the decision-making logic incorporated within the digital token linked to the dataset being processed.

Note, in one or more embodiments, the distributed computing environment is, and/or includes, a trusted distributed computing environment. For instance, in one or more embodiments, the distributed computing environment can originate, or reside, within an entity's intranet or from a trusted third party, including, for instance, another trusted business entity partnering with the entity, where in one or more embodiments, the entity is the dataset owning entity. In one or more embodiments, there is a common protocol that participating distributed computing services of the distributed computing environment need to implement. There are a variety of enabling approaches to enabling security, integrity, and trust, such that participants in the distributed computing environment can be established as trusted, compliant with the specified protocol, and ensure that no vulnerabilities exist that allow protocol to be circumvented and/or allow security integrity of the digital token and its corresponding dataset to become compromised. Further, in one or more embodiments, assuming that security, integrity and trust are established in the computing environment, then the distributed computing services are configured to not make any decisions about how the dataset linked to or corresponding to the digital token is to be processed. Rather, the decision-making logic within the digital token dictates how the corresponding dataset is processed. This gives the dataset owning entity full control over how the dataset is processed within the distributed computing environment.

As illustrated in FIG. 2A, generate digital token for dataset code 202 includes, in one or more embodiments, incorporate decision-making logic code 204 to incorporate decision-making logic (i.e., instructions or program code) into the digital token for processing of the dataset, including, for instance, to control how (e.g., when, where, etc.) the dataset is processed within the distributed computing environment, and generate level(s) of metadata code 206 to generate one or more levels of metadata for the dataset related to processing of the dataset within the distributed computing environment using, at least in part, the decision-making logic. Note that, in one or more embodiments, incorporating decision-making logic into the digital token can include, for instance, generating or configurating the decision-making logic to run processing of for a desired dataset within the distributed computing environment, such as described herein. In one or more embodiments, generate digital token linked-to-dataset code 202 further includes incorporate metadata level(s) code 208 to incorporate the one or more levels of metadata into the digital token, and token code 200 further includes link digital token to dataset code 210 to link (e.g., tether or associate) the digital token to the dataset to facilitate processing of the dataset within the distributed computing environment. In one or more embodiments, token code 200 also includes transmit dataset and linked digital token code 212 to facilitate transmitting the dataset and linked digital token to the distributed computing environment from, for instance, a dataset owning entity computing system (such as from a client computing system), for processing using, at least in part, the decision-making logic, and the one or more levels of metadata, of the digital token.

As depicted in FIG. 2B, in one or more further embodiments, token code 200 also, or alternatively, includes receive dataset and linked token code 220 to receive, for instance, by a distributed computing environment, a dataset and a digital token linked to the dataset, where the digital token facilitates processing, such as control of location of distributed computing service processing, of the dataset within the distributed computing environment. As noted, in one or more embodiments, the digital token can include decision-making logic to facilitate dataset processing within the distributed computing environment and one or more levels of metadata for the dataset related to processing of the dataset within the distributed computing environment. In addition, token code 200 includes, in one or more aspects, process dataset using linked token code 222 to process, or initiate processing of, the dataset within the distributed computing environment using, at least in part, the decision-making logic and the one or more levels of metadata of the digital token linked to the received dataset.

Note also that although various code or sub-modules are described herein, token code, such as disclosed, can use, or include, additional, fewer, and/or different code/sub-modules. A particular code can include additional code, including code of other sub-modules, or less code. Further, additional and/or fewer code/sub-modules can be used. Many variations are possible.

In one or more embodiments, the token code is used, in accordance with one or more aspects of the present disclosure, to perform token processing. FIGS. 3A-3B depict embodiments of different aspects of token processing 300, such as disclosed herein. The processing is executed, in one or more embodiments, by one or more computers (e.g. computer 101 (FIG. 1), computing system 410 (FIG. 4A) and/or machine learning environment 420 (FIG. 4A)(in case of a machine learning environment implementation)), and/or one or more processor sets, such as a processor or processing circuitry (e.g., of processor set 110 of FIG. 1). In one example, code or instructions implementing the process, are part of a code or module, such as token code 200 of FIGS. 1-2B. In other examples, the code can be included in one or more other modules and/or one or more other sub-modules of the one or more modules. Various options are available.

As illustrated in FIG. 3A, in one or more embodiments, token processing 300 executing on one or more computers (e.g., computer 101 of FIG. 1, computing system 410 (FIG. 4A)(in case of a machine learning environment)), and/or one or more processor sets (e.g., processor set 110 of FIG. 1, such as a processor or processing circuitry of the processor set) performs processing such as disclosed herein, which includes, in one or more aspects, generating a digital token for a dataset 302 to facilitate dataset processing within a distributed computing environment. In one or more embodiments, generating the digital token for the dataset 302 includes incorporating (including, for instance, generating or configuring) decision-making logic into the digital token 304 to, for instance, facilitate (e.g., guide, control, provide, etc.) dataset processing within the distributed computing environment, including through one or more distributed computing services of the distributed computing environment, and generating one or more levels of metadata for the dataset related to dataset processing 306. For instance, one or more levels of metadata can be generated for a dataset related to processing the dataset within the distributed computing environment using the decision-making logic. In embodiments, generating the digital token for the dataset 302 further includes incorporating the generated metadata levels into the digital token 308, and token processing 300 further includes linking (e.g., coupling tethering, etc.) the digital token to the dataset 310 to facilitate processing of the dataset within the distributed computing environment. In one or more embodiments, token processing 300 further includes transmitting the dataset and linked digital token to the distributed computing environment for processing 312 using, at least in part, the decision-making logic and the one or more levels of metadata of the digital token.

As noted, in one or more embodiments, the distributed computing environment is, or includes, a trusted, distributed computing environment or ecosystem, which includes, for instance, one or more distributed computing services, such as one or more distributed machine learning services. By way of example only, a distributed machine learning service can be, or include, different machine learning models executing on one or more computing resources to perform a specified service (such as a data classification service), or different machine learning specialty engines executing on one or more computing resources to perform a specified service. For instance, in one or more embodiments, two or more of the machine learning engines can execute on different distributed computing systems, such as computing systems in different countries. Many variations are possible. Further, in one or more embodiments, the distributed computing environment can include one or more distributed non-machine learning services, such as data storage services on heterogeneous data storage resources associated with, for instance, one or more different computing environments, such as one or more public cloud data stores, one or more data center internal data stores, etc., associated with, or accessible by, the distributed computing environment. Note also that, as used herein, a machine learning environment can encompass any defined artificial intelligence (AI) and/or machine learning (ML) computing environment with one or more AI model and/or ML model services, one or more AI engine and/or ML engine services, and/or one or more other types of services, such as data store services, etc., that can be geographically dispersed, and/or differently owned or controlled, or accessed, etc.

As depicted in FIG. 3B, in one or more embodiments, token processing 300 further, and/or alternatively, includes receiving, by a distributed computing environment (such as machine learning environment 420 of FIG. 4A as one example only), a dataset and digital token linked to the dataset for processing 320 within the distributed computing environment. The digital token includes decision-making logic to facilitate processing of the dataset within the distributed computing environment, and one or more levels of metadata for the dataset related to processing of the dataset within the distributed computing environment. In addition, token processing 300 further includes processing the dataset within the distributed computing environment using, at least in part, the decision-making logic and the level(s) of metadata of the digital token linked to the received dataset 322. Many processing options are possible based on the configured decision-making logic of the digital token, and the one or more levels of metadata within the digital token. For instance, in one or more embodiments, the decision-making logic and the one or more levels of metadata of the digital token can be configured to control processing of the dataset, including how the dataset traverses the distributed computing environment. Note that the distributed computing environment can be, or can implement, any of a variety of distributed computing services or operations, which are to be selected or traversed depending on the content of the digital token, which as described herein, is programmed or configured to process, or facilitate processing, the associated dataset. Note that, in one or more embodiments, the decision-making logic can be, for instance, provided by a client system, or dataset originating entity, and can be, or include, program code to be executed on one or more computers of, or associated with, the distributed computing environment. The decision-making logic includes, in one or more embodiments, client or entity program code for handling and/or processing the dataset within the distributed computing environment, using in part, for instance, one or more distributed computing services of the distributed computing environment during the processing of the decision-making logic and dataset.

As disclosed herein, the digital token (or linked-to-dataset token or tethered-to-dataset token) advantageously facilitates processing, including control, monitoring, auditing, etc., of the dataset within a distributed computing environment. In the one or more embodiments described herein below with reference to FIGS. 4A-8B, the distributed computing environment is, or includes, a trusted distributed machine learning environment, with one or more distributed machine learning services. Note that the distributed machine learning environment and processing discussed below represent one or more embodiments only of a distributed computing environment and processing, such as disclosed herein.

Generally, artificial intelligence or machine learning governance is needed for responsible, ethical and compliant exploitation of artificial intelligence and machine learning. Beyond ensuring explainability, trust and auditing of individual machine learning models, governance of the myriad of machine learning resources within an enterprise, in addition to those provided by trusted third parties to an enterprise, should be considered as well. As discussed herein, a machine learning (ML) workflow can involve several ML stages or ML services, possibly involving classification, data splitting based on classification, training, inference processing, etc., each of which can be processed by different trusted machine learning computing resources, such as within an enterprise and/or by one or more trusted third parties, in order to achieve, for instance, optimal exploitation of available computing services and/or resources. In many cases the entity owning a dataset (i.e., the dataset owning entity), in addition to trusted third parties, such as any trusted business partners, etc., can be a multinational organization that has machine learning computer resources that are distributed across different locations, such as across different countries. Note that the use of such distributed machine learning resources, including those provided by trusted third parties, gives the dataset owning entity less control over the dataset and its processing. As such, it is desirable to have a capability to provide the dataset owner more control over how the dataset is processed and how the dataset traverses such as machine learning environment. For instance, in embodiments, it can be desirable for the dataset owner to be able to ensure that they remain compliant with export control, confidentiality, and/or privacy requirements, etc., as the data traverses a distributed machine learning environment. To accomplish this, the dataset owner may need to collect sufficient data, such as sufficient metadata, about how and where their dataset is being processed, stored, etc., within the distributed machine learning environment for explainability, auditing and/or compliance. Additionally, the dataset owning entity may need to guarantee a certain quality of service for one or more machine learning workloads.

Several examples of domains and problems that can be addressed by the digital tokens, or linked-to-dataset tokens, and related processing disclosed herein are set forth below, by way of example only.

As one example, a machine learning workflow involving an entity's system management dataset from an operating system may need to first be processed by a ML data classification model, and then based on the classification, the data may need to be split and fed to two or more specialty machine learning engine (or system) services for training, inference processing, etc. Further, the result of each training and/or inference step may need to be used to either update the machine learning model(s) or provide one or more predictions/recommendations, as desired for a particular implementation.

As another example, a multinational entity may wish to leverage a plurality of geographically diverse computing services (such as two or more geographically diverse machine learning models, machine learning engines, and/or other machine learning-related resources or facilities) which can be provided internally within an entity's intranet, and/or by trusted third parties (e.g., business partners), that may specialize in certain types of machine learning workloads. The dataset owning entity (for instance) might wish to create or define a distributed machine learning environment or ecosystem that is highly optimized to select the best machine learning service or resource for each machine learning workload, while also maintaining compliance with privacy regulations, export control, and one or more entity policies where applicable, meaning that some data may have to be redacted and some data may need to be restricted from being processed by computing services in certain geographies and/or by certain trusted third parties as the data traverses one or more programmed computing services of the distributed machine learning environment.

As a further example, an entity that offers a search engine globally may offer an artificial intelligence (AI) chat bot along with a standard web search engine. The entity can have data centers running the supporting artificial intelligence services (e.g., model(s)) that power the AI chat bot distributed across several countries around the world to ensure that users around the world experience a similar quality of service. The company would also like to be able to use data retained from users'conversations with the chat bot to train and improve the model that powers the chat bot. The company ultimately wishes to ensure it remains compliant with privacy and AI regulations around the world, so the entity needs to ensure that its use of user data and the AI services it provides remain complaint with all the applicable regulations. This can involve limiting which data centers user data can be processed on, ensuring that user data from certain geographies is not used to train the model that powers the AI chat bot without the user's consent, anonymizing user data from certain geographies before it is processed, and even restricting access to the AI chat bot in certain geographies.

Note that the above examples are just a few of the many possible scenarios that involve dataset processing within a distributed computing environment, such as within a distributed computing environment with one or more distributed computing services, such as a trusted machine learning environment with one or more distributed machine learning services as discussed further below with reference to FIGS. 4A-8B, by way of example only.

As a further example, FIGS. 4A-4D depict another embodiment of a computing environment 400 which can incorporate, use or implement, one or more aspects of the present disclosure. In one or more embodiments, computing environment 400 is implemented as part of, or includes, a computing environment such as computing environment 100 described above in connection with FIG. 1. Computing environment 400 contains one or more computer resources 401, such as one or more computers 101 of FIG. 1, connected to receive (e.g., obtain, access, etc.) a dataset and an associated digital token from a client computing system 410. In one or more embodiments, client computing system 410 can be, or include, one or more computers, such as one or more computers 101 of FIG. 1, connected across a network with computer resources 401. In embodiments, computer resource(s) 401 implement a distributed machine learning environment 420 configured to process a dataset and linked digital token, such as described herein.

As illustrated, one or more different aspects of token code 200 can reside on, or be associated with, client computing system 410, as well as with machine learning environment 420, in one or more embodiments. For instance, different aspects of token code 200 can be implemented at different computer resources, depending upon the particular code aspect. As one example, the token code 200 described above in connection with FIG. 2A can be implemented as part of, included within, or executed by, client computing system 410 of FIG. 4A, and the token code 200 described above in connection with FIG. 2B can be implemented as part of, included within, or executed by, one or more computer resources 401 running machine learning environment 420, in one example.

In one or more embodiments, the distributed computing environment (or ecosystem) as described herein, such as machine learning environment 420, is, or includes, a heterogeneous distributed computing environment which has or offers, for instance, one or more computing services, such as one or more distributed computing services. As noted, the digital token facilitates processing within a distributed computing environment with one or more distributed computing services, such as one or more distributed machine learning services of a dataset owning entity and/or a trusted business partner. As noted, there is a common protocol that all participating machine learning services are configured to implement. Various ways of implementing such a trusted machine learning environment are apparent to those skilled in the art, including ways of enabling security, integrity, and trust so that the participants in the environment can be established as trusted, compliant with the protocol, and ensure no vulnerabilities exist that allow the protocol to be circumvented or allow the security or integrity of the token and its corresponding data or code to become compromised. Where there is adequate security, integrity and trust within the machine learning environment, the participating machine learning services are configured to not make any decisions on how the dataset corresponding to the token is processed. Rather, the decision-making logic of the digital token dictates how the corresponding dataset is to be processed, giving the dataset owner enhanced control over how the data is processed within the machine learning environment. Note that existing enabling art for maintaining security or integrity can be implemented in embodiments of the processing disclosed herein, including, but not limited to, encryption, signing and blockchain. For instance, technologies used in blockchain can serve as enabling approaches for maintaining integrity of the immutable metadata level, append only metadata level and/or clone mutable metadata level of the digital token linked to the dataset.

By way of example, a distributed machine learning service 422 can be, or include, a plurality of machine learning engines executing on one or more distributed computing resources, which are configured to perform a specified machine learning service. For instance, in one or more embodiments, the service can be a training service, or an inference service, etc. One example of this is depicted in FIG. 4B. As illustrated in FIG. 4B, in one embodiment, the plurality of machine learning engines of a particular distributed machine learning service can include, by way of example only, five specialty machine learning (ML) engines 1-5 430, with specialty ML engines 2-4 being intranet accessible engines (e.g., within an entity owning the dataset being processed, or within an entity processing the dataset), and one or more other specialty engines being Internet accessed, such as specialty ML engines 1 & 5 in the example of FIG. 4B. Further, note that the different specialty ML engines can be located in different geographic regions, such as in different countries, with specialty ML engines 1-3 being located in country 1 and specialty ML engines 4-5 being located in country 2 in the example of FIG. 4B.

As illustrated in FIG. 4A, the computing services of machine learning environment 420 can further, or alternatively, be or include, a plurality of distributed machine learning models associated with, or providing, a particular machine learning service 424. In the embodiment of FIG. 4C, machine learning service 424 includes, by way of example only, five machine learning models 1-5 431. In this embodiment, machine learning models 2-4 are accessed via an intranet. In one or more embodiments, the machine learning models 2-4 can be executing on computer resources of the dataset owning entity or a dataset processing entity and/or one or more trusted third party entities, with the intranet and/or computer resources being created, specified and/or preconfigured as part of the distributed machine learning environment. In this example, machine learning models 1 & 5 are accessible via the Internet, as one example only. Note also that, in the example of FIG. 4C, machine learning models 1-3 are geographically located in country 1, and machine learning models 4 & 5 are geographically located in country 2, again by way of example only.

As illustrated in FIG. 4A, machine learning environment 420 can further include one or more other services, such as one or more distributed data store services 426, which can reside on, be associated with or accessed by, distributed computing resources. By way of example, FIG. 4D depicts one embodiment of distributed data stores 426, which can include data stores distributed across multiple computer resources of the distributed machine learning environment. By way of example, distributed data stores 426 can include a public cloud 1 data store and a public cloud 2 data store 432, as well as internal data center 1-3 data stores 433, again in one embodiment only. As depicted, in embodiment, internal data center 1-3 data stores 433 are accessed via an intranet, such via an intranet of an entity owning the dataset to be processed, and public cloud 1 & 2 data stores 432 are accessed via the Internet, as one example only. Further, in the embodiment illustrated, public cloud 1 data store 432 and internal data center data stores 1 & 2 433 are located in country 1, while internal data center 3 data store 433 and public cloud 2 data store 432 are located in country 2, again by way of example only.

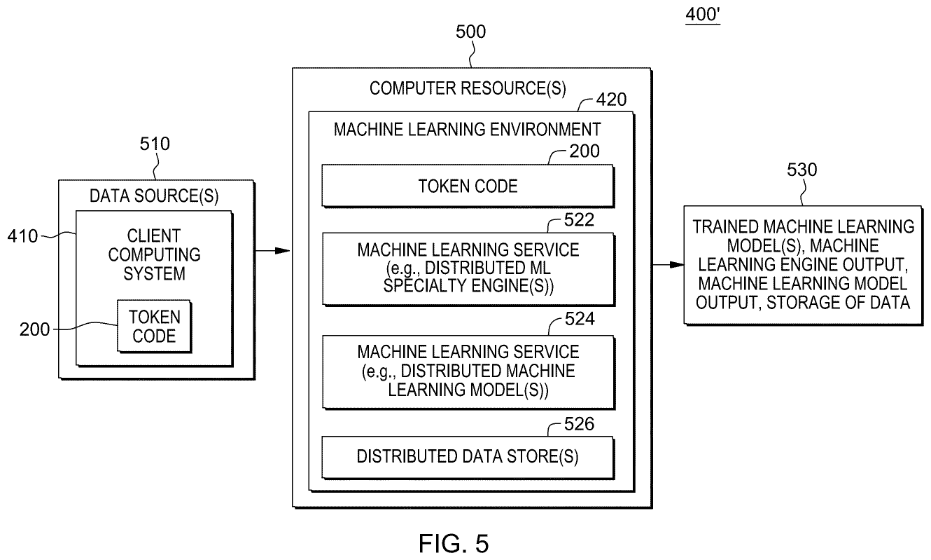

By way of further example, FIG. 5 depicts another embodiment of a computing environment 400′, which can incorporate, use or implement, one or more aspects of an embodiment of the present disclosure. In one or more embodiments, computing environment 400′ is implemented as part of, or includes, one or more aspects of a computing environment such as computing environment 400 described above in connection with FIGS. 1 & 4A-4D. Computing environment 400′ contains one or more computer resources 500, such as one or more computers 101 of FIG. 1, connected to receive (e.g., obtain, access, etc.) data or datasets from one or more data sources 510, such as one or more client computing systems 410 (e.g., one or more dataset owning entity computing systems), with the one or more datasets to processed within distributed machine learning environment 420. The one or more datasets have one or more linked digital tokens associated with the datasets generated, for instance, by a token code, such as token code 200 described above in connection with FIG. 1-2B.

In embodiments, the one or more computer resources 500 execute program code that runs or implements, for instance, one or more distributed machine learning environments 420 that execute or include one or more aspects of token code 200, such as disclosed herein. In one or more embodiments, distributed machine learning environment 420 further includes, for instance, one or more machine learning services, such as a machine learning service 522, which includes multiple distributed specialty machine learning engines providing a specified service. In one or more embodiments, distributed machine learning environment 420 can further include another machine learning service 524, such as distributed machine learning models configured to perform a specified machine learning service. Further, in one or more embodiments, distributed machine learning environment 420 can include non-computing services, such as a distributed data store service 526, in one example.

As disclosed herein, token code 200 associated with or executing within machine learning environment 420 can, for instance, facilitate receiving a dataset and a linked digital token for the dataset to facilitate processing of the dataset within machine learning environment 420. For instance, in one or more embodiments, the digital token linked to the dataset includes decision-making logic to be executed, to, for instance, control how the dataset is processed with the machine learning environment, including by one or more distributed machine learning services, 522, 524. In addition, the digital token linked to the dataset includes one or more levels of metadata for the dataset related to processing of the dataset within the machine learning environment using the decision-making logic, such as described further herein. By way of example, machine learning environment 420 facilitates or provides various outputs depending upon the incorporated decision-making logic of the digital token and the machine learning services implemented within the distributed machine learning environment. For instance, in one or more embodiments, the machine learning environment 420 can train, and/or provide, one or more machine learning models, one or more machine learning engine outputs, one or more machine learning model outputs, and/or provide other outputs or initiate actions, such as facilitating storage of data in a distributed data store, and/or provide recommendations or predictions 530. Note that these are examples only of processing which can be provided and/or facilitated via the machine learning environment 420 with the token code and digital token disclosed herein. In one or more examples, the output, recommendations, predictions, actions, etc., 530 provided by distributed machine learning environment 420 can be transmitted to one or more other computing systems, such as to client computing system 410, as desired for a particular implementation. Many possibilities exist.

In one or more implementations, computing environment 400′ can include, or utilize, one or more networks for interfacing various aspects of computer resource(s) 500, data source(s) 510, as well as one of or more other controllers, components, systems, etc., receiving a result, action, instruction, etc. 530 of the token code 200, and/or machine learning environment 420, in a manner that facilitates improved processing, such as disclosed herein. By way of example, the network(s) can be, for instance, a telecommunications network, a local area network (LAN), an intranet, a wide area network (WAN), such as the Internet, or a combination thereof, and can include wired, wireless, fiber optic connections, etc. The network(s) can include one or more wired and/or wireless networks that are capable of receiving and transmitting data, including (for instance) training data for one or more machine learning model(s) of a distributed machine learning (ML) service as discussed herein, and an output solution, recommendation, action of the code, and/or distributed machine learning environment, such discussed herein.

In one or more implementations, computer resource(s) 500 house and/or execute program code configured to perform computer-implemented methods in accordance with one or more aspects of the present disclosure. By way of example, computer resource(s) 500 can be a computing-system-implemented resource(s). Further, for illustrative purposes only, computer resource(s) 500 in FIG. 5 is depicted as being a single computer resource. This is a non-limiting example of an implementation. In one or more other embodiments, computer resource(s) 500 can be, or be implemented in, multiple separate computer resources or systems, such as one or more geographically distributed computer resources, as in the embodiments of FIGS. 4A-4D.

Briefly described, in one embodiment, computer resource(s) 500 can include one or more processor sets with one or more processors, for instance, central processing units (CPUs). Also, the processor set(s) can include functional components used in the integration of program code, such as functional components to fetch program code from locations in memory, such as cache or main memory, decode program code, and execute program code, access memory for instruction execution, and write results of the executed instructions or code. The processor set(s) can also include a register(s) to be used by one or more of the functional components. In one or more embodiments, the computing resource(s) can include memory, input/output, a network interface, and storage, which can include and/or access, one or more other computing resources and/or databases, as required to implement the inference processing code processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computer resource(s), or computing system(s) or controller(s), which can implement one or more aspects disclosed are described further herein.

In one or more embodiments, program code includes, executes, accesses, etc., one or more machine learning services 522, 524 of machine learning environment 420 in processing token code 200 for a particular dataset and linked digital token. As discussed herein, in one or more embodiments, the distributed machine learning services can include training a machine learning model and/or using one or more machine learning models, engines, etc. Training one or more machine learning models can include using the dataset and/or other datasets as input data to train the machine learning model, which the program code can then utilize to, for instance, implement one or more aspects of the incorporated decision-making logic of the digital token linked to the dataset or other datasets, such as, for instance, one or more aspects of machine learning classification processing, machine learning inference processing, etc. In an initialization or learning stage, the program code can train the one or more machine learning models using obtained training data to implement, for instance, one or more aspects of the machine learning code, function and/or tools disclosed herein.

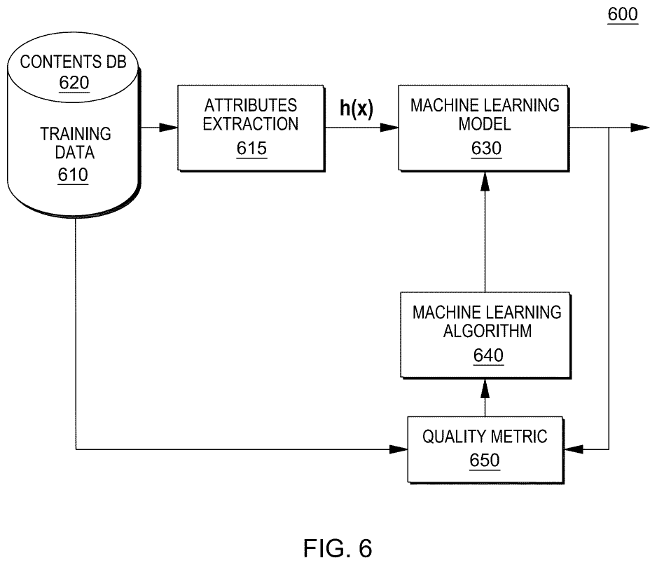

One example of a machine learning training system is depicted in FIG. 6. In one or more embodiments, a machine learning training system 600 can be utilized to perform cognitive analysis of various inputs, including input data, data from one or more sources, repositories, data structures and/or other data. The data can include, for instance, one or more datasets, such as discussed herein. Program code, in embodiments of the present disclosure, can perform data analysis to generate data structures, including algorithms utilized by the program code to implement one or more aspects of (for example) inference processing and/or initiate (or perform) an action related thereto. As known, machine learning-based modeling solves problems that cannot be solved by numerical means alone. In one example, program code extracts features/attributes 615 from the training data 610, which can be stored in memory or one or more databases 620. The extracted features can be utilized to develop a predictor function, h(x), also referred to as a hypothesis, which the program code utilizes as a model 630.

In identifying various states, features, attribute similarities, constraints and/or behaviors indicative of states in the ML training data 610, the program code can utilize various techniques to identify attributes in an embodiment of the present disclosure. Embodiments of the present disclosure utilize varying techniques to select attributes (data attributes, elements, patterns, features, constraints, distribution, etc.), including but not limited to, diffusion mapping, principal component analysis, recursive feature elimination (a brute force approach to selecting attributes), and/or a Random Forest, to select the attributes related to various events. The program code may utilize a machine learning algorithm 640 to train the machine learning model(s) 630 (e.g., the algorithms utilized by the program code), including providing weights for the conclusions, so that the program code can train the predictor functions that comprise the machine learning model(s) 630. The conclusions may be evaluated by a quality metric 650. By selecting a diverse set of ML training data 610, the program code trains the machine learning model(s) 630 to identify and weight various attributes (e.g., data attributes, features, patterns, constraints, distributions, etc.) that correlate to various states or events of a process.

The model generated by the program code can be self-learning as the program code updates the model based on event feedback, as well as from the feedback received from data related to identifying an event. For example, when the program code determines that there is a constraint, event, similarity or pattern (e.g., data attribute, record attribute similarity, query pattern, data distribution, search terms distribution, etc.) that was not previously predicted by the model, the program code can utilize a learning agent to update the model to reflect the state of the event, in order to improve predictions in the future. Additionally, when the program code determines that a prediction is incorrect, either based on receiving user feedback through an interface or based on monitoring related to an event, the program code can update the model to reflect the inaccuracy of the prediction for the given period of time. Program code including a learning agent cognitively analyzes any data deviating from the modeled expectations and adjusts the model to increase the accuracy of the model, moving forward.

In one or more embodiments, the program code can utilize one or more neural networks (NNs) to analyze training data and/or collected data to generate an operational machine learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present disclosure, can utilize in implementing a machine learning model, such as described herein.

Note that, depending upon the embodiment, the trained machine learning model can retain, at least in part, one or more levels of metadata of the digital token linked to the dataset used in training the machine learning model, in one or more embodiments. For instance, in one embodiment related to model training, the dataset owning entity could include in the decision-making logic of the digital token that certain metadata from the digital token is to be retained in the trained model, for instance, for explainability and auditing purposes. In another embodiment related to an artificial intelligence chatbot service, the dataset owning entity could dictate by the decision-making logic and the associated digital token whether user data can be retained by the service provider and/or used for further machine learning model training. Note also that one or more embodiments of the capabilities disclosed herein are applicable to foundational and base model training, in one or more embodiments.

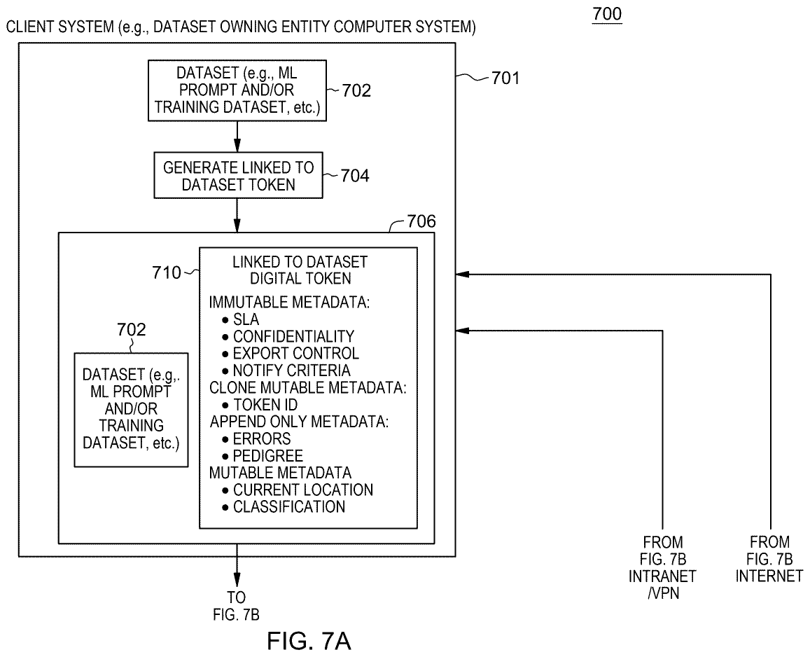

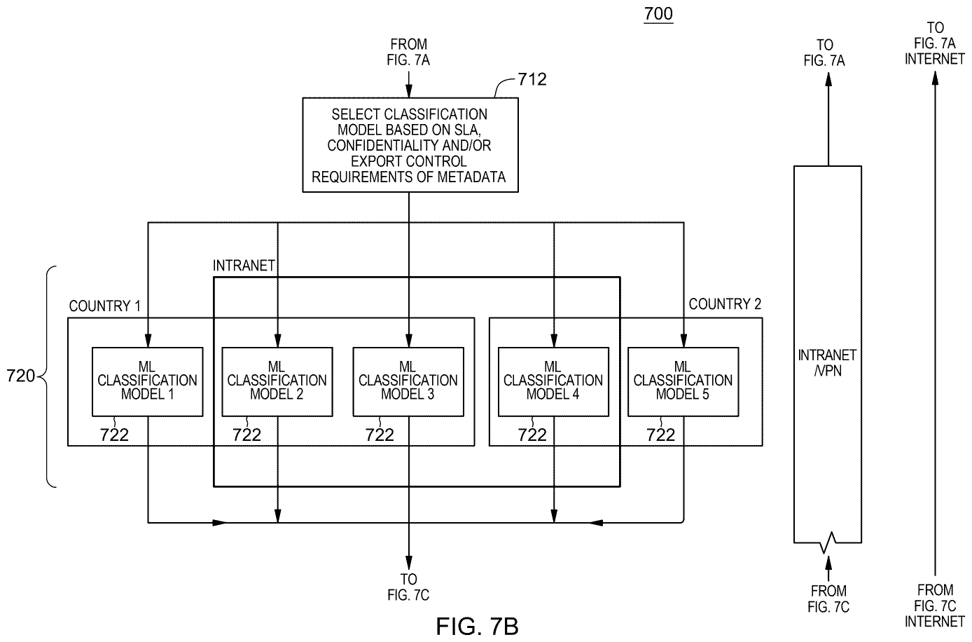

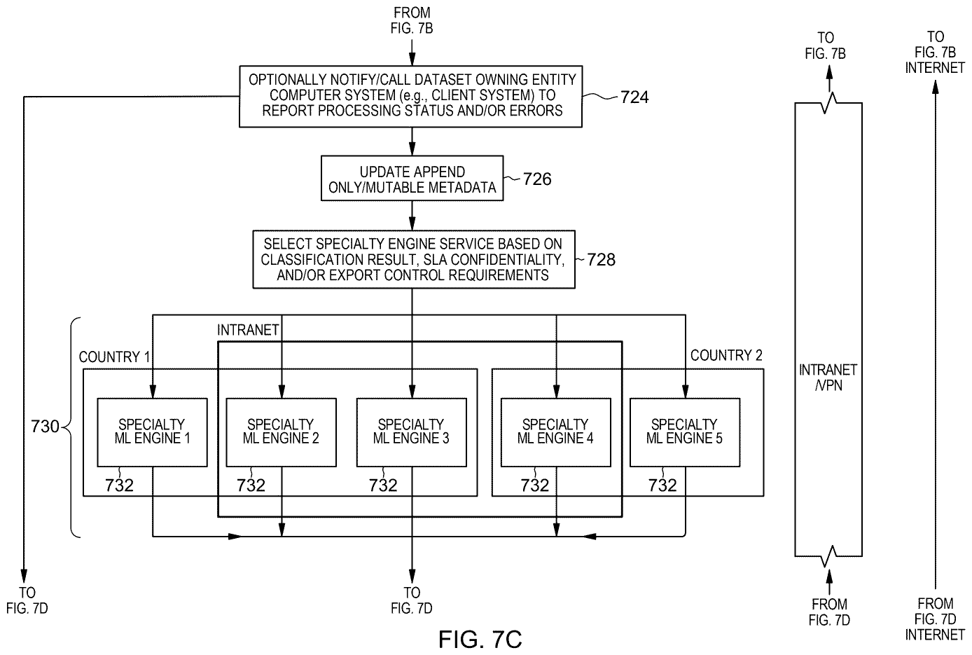

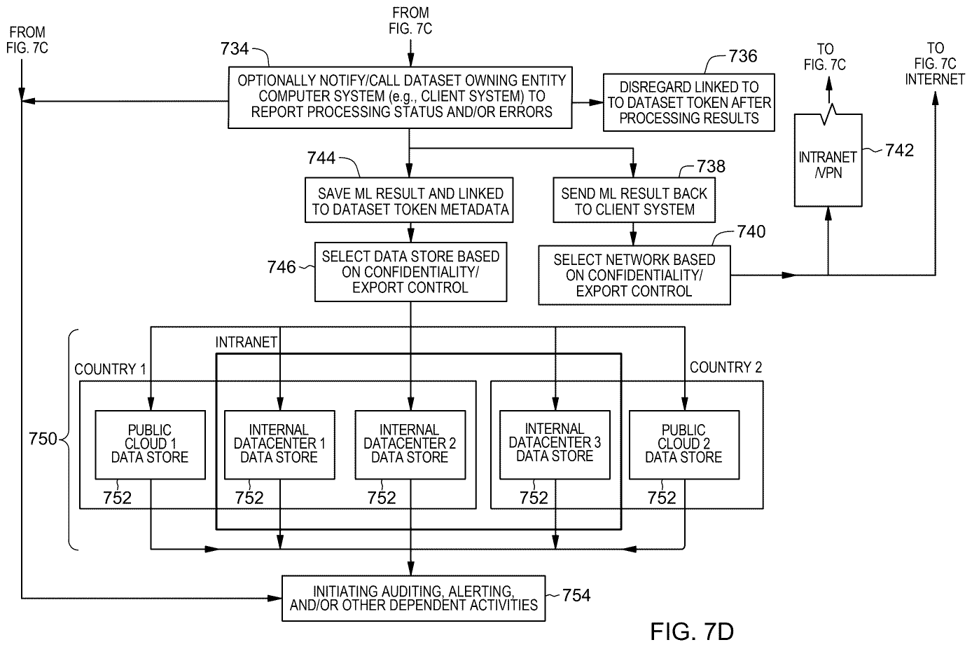

FIGS. 7A-7D depict one detailed embodiment of a digital token and distributed machine learning environment process 700, in accordance with one or more aspects of the present disclosure. The digital token and distributed machine learning environment process can be implemented, by way of example, on one or more computer resources such as described above in connection with FIGS. 1-6, by way of example. For instance, as described herein, digital token and distributed machine learning environment process 700 can be implemented via a client computing system and a preconfigured machine learning environment or ecosystem which includes or executes various machine learning resources that are accessed via an intranet and/or a public Internet using predefined protocols for the environments. As illustrated in FIG. 7A, a client system 701, such as client computing system 410 described above in connection with FIGS. 4A-5, obtains a dataset, such as data with a machine learning prompt, a training dataset, other dataset, and/or a machine learning model, etc. 702, and generates 704 a linked-to-dataset digital token 710, such as described herein. As discussed, the linked-to-dataset digital token (i.e., tethered to data token) includes decision-making logic to be executed and initial metadata for the associated dataset.

In one or more embodiments, the digital token is initialized with multiple levels of metadata including, for instance, an immutable metadata level, a clone mutable metadata level, an appended only metadata level and/or mutable metadata level. Depending upon the level, integrity can be maintained using a variety of technologies. For instance, technologies used in blockchain can serve as enabling processes for maintaining integrity of the immutable metadata level, append only metadata level, and clone mutable metadata level in the digital token. Note that the exact information or metadata maintained in each digital token is dependent on the particular processing embodiment. In embodiments, the immutable metadata can include dataset owning entity information (such as owner name or universal unique identifier (UUID)), service level agreement (SLA) requirements for the associated dataset, privacy requirements for the dataset, confidentiality requirements for the dataset, export control requirements for the dataset and/or notification/alert criteria requirements for the dataset when processed within the distributed machine learning environment. The clone mutable metadata can include, in one or more embodiments, a level of metadata that indicates a token ID of the digital token is clone mutable during processing of the dataset within the distributed machine learning environment. The appended only metadata level for the dataset can indicate, in one or more embodiments, that one or more: an error occurring during processing of the dataset within the distributed machine learning environment is to be appended to the metadata, and/or pedigree information is to be appended to the metadata during processing of the dataset within the distributed machine learning environment. In embodiments, the mutable metadata level for the dataset can be initiated or configured to hold at least one of current location data of the dataset when being processed within the distributed machine learning environment, and/or classification of the dataset when being processed within the distributed computing environment, etc. Further, in one or more embodiments, the decision-making logic can include logic that when executed determines whether to issue, for instance, a call home (using available criteria of the metadata), such as to provide a status report, as well as how the associated dataset is to be processed, and how the dataset is to traverse the distributed machine learning environment during processing.

In one or more embodiments, the digital token 710 is linked 706 to the dataset 702 to facilitate processing of the dataset within the distributed machine learning environment or ecosystem. The distributed machine learning environment includes, in one or more embodiments, one or more distributed data classification models, one or more distributed specialty engines for training and/or inference, and one or more distributed data stores as illustrated in the example of FIGS. 7B-7D. Further, by way of example only, the distributed machine learning resources are distributed between, for instance, two different countries and certain machine learning resources are accessed either through the Internet or an internal intranet or a virtual private network (VPN). Note that FIGS. 7A-7D depict one embodiment only of processing within a distributed machine learning environment using a digital token, with decision-making logic and levels of metadata, such as described herein.

In the embodiment of FIG. 7B, the decision-making logic of the digital token includes logic (i.e., program code or instructions) to select a classification model based on SLA, confidentiality and/or export control requirements of the metadata within the linked digital token 712, that is, in one embodiment, decision-making logic 712 facilitates selecting a particular machine learning classification model service 720 for processing of the dataset. In the example of FIG. 7B, machine learning classification model service 720 can include a distributed set of machine learning classification models 1-5 722 providing the same, or similar service, with, for instance, machine learning classification models 2-4 722 being accessed via an intranet or VPN, and machine learning classification models 1 & 5 722 beings accessed via a public Internet, by way of example only. In addition, the decision-making logic of the digital token can consider the geographic location of the respective machine learning classification models, which in the example of FIG. 7B includes machine learning classification models 1 . . . 3 being located in country 1, and machine learning classification models 4 & 5 being located in country 2, again by way of example only. In one or more embodiments, the classification model can be selected by the decision-making logic based on the SLA requirements, confidentiality requirements, and/or export control requirements of the immutable metadata incorporated within the digital token linked to the dataset.

As illustrated in FIG. 7C, in one or more embodiments, the decision-making logic can be configured or programed to issue a status report or a call home with, for instance, processing status and/or detected errors during processing being reported 724. In one embodiment, the report is issued to a client computing system providing the dataset and linked digital token, such as a computing system of the dataset owning entity system. As a further embodiment, the report can be issued to a central server, such as to a central server of the dataset owning entity, by way of example. In the embodiment of FIG. 7C, the decision-making logic can further include an update append only/mutable metadata code process 726, which when executed updates the append only and/or mutable metadata of the digital token based, for instance, on the results of the classification stage or service of the distributed computing environment and/or other situational information of the distributed computing environment processing of the dataset.

In the embodiment of FIG. 7C, the decision-making logic is further configured to select a specialty machine learning engine for model training and/or inference processing based on the result of the classification, in addition to, for instance, the SLA requirements, confidentiality requirements, and/or export control requirements 728 within the digital token, such as described herein. An example of the specialty machine learning engine service 730 is depicted in FIG. 7C, which includes, by way of example only, five specialty machine learning engines 1-5, with specialty machine learning engines 2-4 being accessed through a predefined intranet or VPN (e.g., of the dataset owning entity) and specialty machine learning engines 1 & 5 732 being accessed via a public Internet. In the example of FIG. 7C, specialty ML engines 1-3 are indicated as geographically located within country 1, and by way of example, specialty ML engines 4 & 5 are located within country 2. Those skilled in the art will understand this processing and service represent one embodiment only of a distributed machine learning service which can process a dataset using the dataset's linked digital token, such as described herein.

As illustrated in FIG. 7D, with the selected specialty engine finishing processing of the dataset, the decision-making logic of the digital token can issue a call home to report status and/or errors to, for instance, the client computing system of the dataset owning entity 734. In one or more embodiments, the decision-making logic can further instruct the distributed machine learning environment to disregard the linked digital token after the machine learning processing results have been obtained 736.

As further illustrated in FIG. 7D, in one or more embodiments, the decision-making logic can send a machine learning result, and linked-to-dataset token metadata, back to the client computing system 738, with the network used to transmit the machine learning result being selected by the decision-making logic based on, for instance, confidentiality requirements and/or export control requirements of the immutable metadata of the digital token 740. As discussed, in one or more embodiments, the digital token and distributed machine learning environment processing can transfer data via one or more intranets and/or VPNs 742 associated with, for instance, the dataset owning entity, and/or via a public Internet, with the machine learning result being sent to the client computing system (in one example) using the selected network.

In one or more embodiments, the decision-making logic can further be configured or programmed to save the machine learning result and the dataset metadata 744 and can select a data store based, for instance, on confidentiality and/or export control requirements of the digital token metadata 746. In the example of FIG. 7D, a distributed data store 750 can be provided as part of the distributed machine learning environment, and/or accessed by the distributed machine learning environment, and can include, in one or more embodiments, internal data center 1-3 data stores 752 accessed via a defined intranet or VPN, as well as public cloud 1 & 2 data stores 752 accessed via a public Internet. In the example of FIG. 7D, the public cloud 1 data store, internal data center 1 data store, and internal data center 2 data store are depicted as geographically located in country 1, and internal data center 3 data store and public cloud 2 data store are shown geographically located in country 2, again by way of example only. In one or more embodiments, the digital token decision-making logic can initiate storing of the machine learning result and the relevant digital token metadata in the selected data store. Further, in one or more embodiments, the decision-making logic of the digital token can initiate an auditing, alert, and/or other dependent processing activity 754 based on the machine learning result and/or based on storage of the machine learning result and the associated digital token metadata.

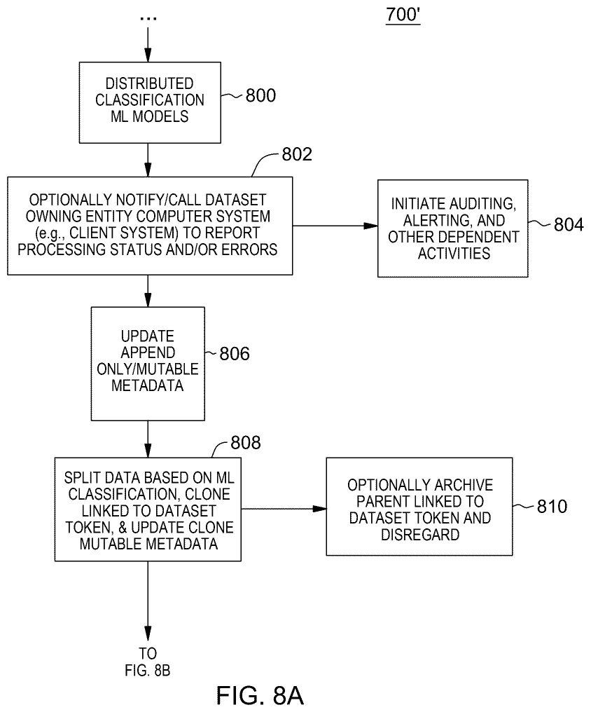

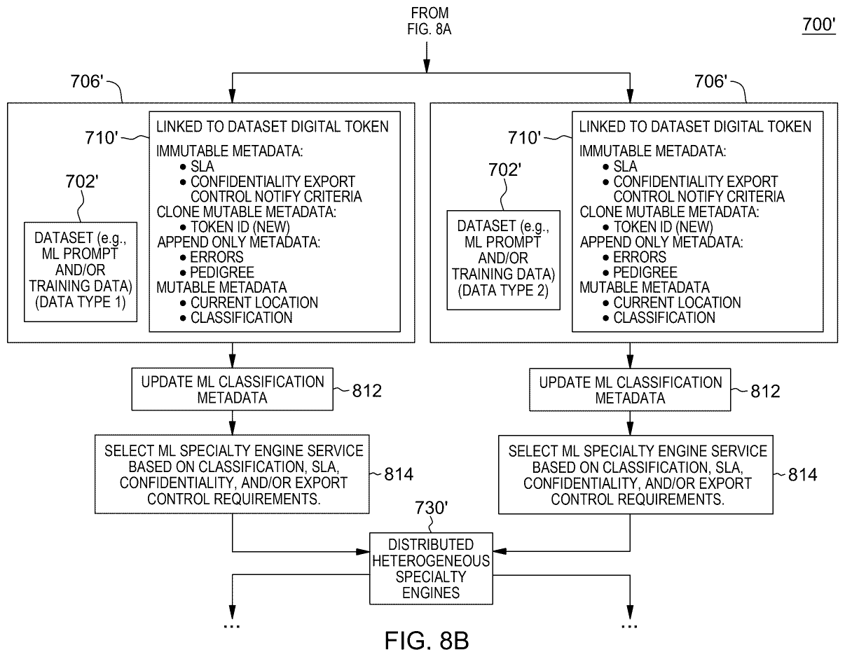

FIGS. 8A-8B depict another embodiment of a digital token and distributed machine learning environment process 700′, in accordance with one or more aspects of the present disclosure. The digital token and machine learning process can be implemented, by way of example, using one or more computer resources such as described above in connection with FIGS. 1-6, by way of example. For instance, as described herein, digital token and machine learning environment process 700′ can be implemented by a client computing system and a distributed machine learning environment or ecosystem, which includes or executes various machine learning resources via, for instance, an intranet, VPN and/or a public Internet. As illustrated in FIG. 8A, in one or more embodiments, after distributed classification ML model processing 800, such as described above in connection with FIG. 7B, the decision-making logic can optionally issue a call home (e.g., call to the dataset owning entity computer system (e.g., client computing system)) to report processing status and/or errors 802. Further, an auditing process, alerting process, or other dependent activity process 804 can be issued based on the processing status and/or errors reported.

As illustrated in FIG. 8A, digital token and distributed computing environment process 700′ can further include an append only and/or mutable metadata update process based on the results of the processing through, for instance, the distributed classification ML models, and/or other situational process information 806.

In one or more embodiments, and by way of example only, based on the results of the data classification, the dataset can be split by the decision-making logic into two disparate data chunks with different data classifications denoted by data type 1 and data type 2 808. Further, in one or more embodiments, the linked-to-dataset token, or digital token, can be cloned, and the clone mutable metadata updated as part of the splitting process. Optionally, the parent digital token (i.e., linked-to-dataset token) can be archived and disregarded in further processing of the dataset within the machine learning environment 810. As illustrated in FIG. 8B, in one or more embodiments, the parent digital token is cloned into two child digital tokens (i.e., clone digital tokens) 710′, which are linked 706′ to the respective new dataset chunks of data type 1 and data type 2 702′. As illustrated, the split data types 1 & 2 702′ with the corresponding clone digital tokens 710′ can be separately processed, for instance, in parallel through a requested machine learning service. In one or more embodiments, the clone digital tokens 710′ are identical to the parent digital token, except that each clone digital token gets a new unique token ID, which is allowed since the token ID is part of the clone mutable metadata of the parent digital token. In one or more embodiments, pedigree information that keeps track of any ancestor tokens can be maintained as append only metadata in the clone digital tokens.

As illustrated, in one or more embodiments, the decision-making logic process updates the machine learning classification metadata 812 according to the classification of the respective dataset chunk type 1 & 2 of the clone digital token it is attached to. Note that the immutable metadata is not changed, even during token splitting. In one or more embodiments, the parent digital token is disregarded and optionally archived for auditing purposes, with each dataset chunk now being distinct, and processing continues for each dataset chunk in parallel, as illustrated in FIG. 8B. For instance, in one or more embodiments, the decision-making logic of the respective clone digital token proceeds to select a machine learning specialty engine service based on the classification, as well as the associated immutable metadata such as the SLA, confidentially and/or export control requirements of the immutable metadata 814. A specialty engine is then selected from several distributed heterogenous specialty engines 730′, such as described above in connection with the distributed heterogenous specialty engines 730 of the processing of FIG. 7C (by way of example only). In this embodiment, each dataset chunk can then be processed by the selected specialty engine in parallel, and process continues separately for each dataset chunk until all digital token and distributed computing environment processing is complete.

Note that many processing variations are possible, and the examples of FIG. 7A-8B represent only selected embodiments of the different processing which can be implemented by the digital token and distributed computing environment process, as described herein. As with the processing of FIGS. 7A-7D, the respective clone digital token can be disregarded and the respective machine learning results and relevant metadata collected by the digital token can be stored in a selected data store, and the machine learning result and/or collective metadata can be sent back to the client computing system via, for instance, the Internet or an internal intranet of VPN.

Those skilled in the art will note from the description provided herein that a digital token is disclosed linked to a dataset which is to traverse a distributed computing environment or ecosystem to, for instance, facilitate learning and/or inference system processing, and to provide a variety of different types of decision-making logic processing, such as a call home and other decision-making logic processing, along with multiple levels of associated metadata being provided with the digital token. By way of example, the multiple levels of metadata can include an immutable metadata level defined, for instance, before the dataset and associated digital token enter the distributed computing environment. The immutable metadata cannot be modified in any way during the life cycle of the digital token. This also includes scenarios where the digital token is cloned due to the corresponding data being split into two or more separate data chunks.

In one or more embodiments, the multiple levels of metadata can also include clone metadata that is defined as part of the digital token before the dataset and digital token enter the distributed computing environment. Clone mutable metadata can only be modified when the digital token is cloned due to the corresponding dataset being partitioned and separated. Otherwise, clone mutable metadata cannot be modified in any way during the lifecycle of the digital token.

In one or more embodiments, the multiple levels of metadata can include append only metadata that is added to the digital token to traverse the distributed computing environment. The appended only metadata cannot be deleted after it is added to the digital token. This also includes scenarios where the digital token is cloned due to the corresponding dataset being partitioned and separated.

In embodiments, the multiple levels of metadata can further include mutable metadata, which is a level of metadata that is added to and updated as the digital token and dataset traverses the distributed computing environment to, for instance, provide current location information, classification information, etc., on the dataset processing.

In one or more embodiments, decision-making logic of the digital token executes as the dataset and linked digital token traverse the distributed computing environment using, for instance, the one or more levels of metadata of the digital token and/or other information obtained during the processing of the dataset within the distributed computing environment. In one or more embodiments, a handoff process or protocol is implemented between the decision-making logic processing of the digital token and the one or more distributed computing services (e.g., one or more distributed machine learning services) of the distributed computing environment with, for instance, the decision-making logic dictating how the corresponding dataset is processed within the distributed computing environment, and the participating computing services (e.g., participating machine learning processing services) not making any decisions about how the dataset corresponding to the digital token is processed through the services.

In one or more embodiments, the decision-making logic (e.g., program code or instructions) is contained within the digital token, meaning that the decision-making logic contained within the digital token dictates how it and the corresponding dataset traverses the distributed computing environment. The decision-making logic is also responsible for deciding, for instance, when to issue a call home, as well as for deciding what criteria are used for issuing a call home, for instance, to provide a status report. In one or more embodiments, a call home can be issued by the decision-making logic based on any arbitrary criteria using the digital token metadata and/or other data as the digital token and linked dataset traverse the distributed computing environment.

As discussed, where the dataset associated with the digital token is to be split into two or more separate dataset chunks, then the digital token will be cloned, and the clone digital tokens will be attached to the respective separated dataset. In one or more embodiments, the parent digital token linked to the dataset can be disregarded after all processing on the dataset within the distributed computing environment is complete. The only exception is the scenario where the dataset associated with the digital token is split into two or more separate dataset chunks, where the parent digital token will be disregarded, and the clone digital tokens will be attached to the corresponding separated datasets for further processing.

In one or more embodiments, the dataset is configured (i.e., specifically constructed) for the dataset to traverse one or more distributed computing services of a distributed computing environment, such as the distributed machine learning environment illustrated in the embodiments of FIGS. 7A-8B.

As noted, in accordance with one or more aspects of the present disclosure, a capability is provided to facilitate processing within a computing environment, and more particularly, to facilitate dataset processing within a distributed computing environment or ecosystem. In one or more aspects, a digital token is generated for a dataset to be processed within a distributed computing environment, where the digital token includes decision-making logic to facilitate dataset processing within the distributed computing environment, and one or more levels of metadata for the dataset related to processing of the dataset within the distributed computing environment using, at least in part, the decision-making logic. As described herein, the digital token is linked to the dataset to facilitate processing the dataset within the distributed computing environment, including by one or more distributed computing services of the distributed computing environment. A variety of advantages and technological effects are described throughout the detailed description provided. For instance, the linked digital token methods described herein facilitate auditing of distributed machine learning systems using the linked digital token to, for instance, collect pertinent metadata and preserving auditing information via a call home mechanism, and/or ensuring that the data is preserved after the dataset is done being processed. In one or more embodiments, the dataset linked digital token facilitates, for instance, artificial intelligence (AI) explainability by enabling, for instance, full pedigree of a machine learning model and/or recommendation or prediction to be created based on how the corresponding dataset is processed and how it traverses the distributed computing environment or ecosystem. The linked digital token further facilitates compliance by ensuring that a dataset being fed into a distributed computing environment can be tagged with immutable metadata such as dataset owning entity information (such as owner name or universal unique identifier (UUID)), confidentiality data, privacy data, and export control data, so that the corresponding dataset is processed and traverses the distributed computing environment based on the provided compliance metadata. In one or more embodiments, the linked digital token facilitates compliance that sensitive information can be redacted from the dataset traversing the distributed computing environment based, for instance, on situational metadata and compliance metadata, such as confidentiality, privacy and/or export control requirements recorded as immutable metadata. In one or more embodiments, the linked digital token facilitates ensuring that when a dataset traverses a distributed computing environment and is split into two or more dataset chunks based, for instance, on the results of a classification model, that the child dataset chunks also inherit the digital token (including the decision-making logic and metadata) of the parent dataset during the data splitting operation. In one or more embodiments, the linked digital token ensures that available machine learning resources in a distributed machine learning environment can be exploited in a most optimal way possible according to, for instance, a service level agreement (SLA) requirement, while also remaining compliant with all applicable rules and regulations for the dataset processing. In one or more embodiments, the linked digital token further provides a dataset owning entity significant control over how the dataset is processed within the distributed computing environment, as described herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A method comprising:
generating a digital token for a dataset to be processed by a distributed computing environment, the distributed computing environment including a distributed computing service, and generating the digital token comprising:
incorporating decision-making logic into the digital token to facilitate dataset processing within the distributed computing environment;
generating one or more levels of metadata for the dataset related to processing of the dataset within the distributed computing environment using the decision-making logic, and incorporating the one or more levels of metadata into the digital token;
linking the digital token to the dataset to facilitate control of processing of the dataset within the distributed computing environment, including by the distributed computing service; and
transmitting the dataset and linked digital token to the distributed computing environment for processing using, at least in part, the decision-making logic and the one or more levels of metadata of the digital token.

2. The method of claim 1, wherein the decision-making logic of the digital token directs, with reference to the one or more levels of metadata, traversal of the dataset through the distributed computing service of the distributed computing environment during processing.

3. The method of claim 1, wherein incorporating the decision-making logic into the digital token further comprises incorporating decision-making logic into the digital token for a status report call during processing of the dataset within the distributed computing environment, and wherein executing the status report call references, at least in part, the one or more levels of metadata incorporated into the digital token in sending a status report from the distributed computing environment to an identified computing system identified via the digital token.

4. The method of claim 1, wherein generating the one or more levels of metadata comprises generating one or more of an immutable metadata level, a clone mutable metadata level, an append only metadata level and a mutable metadata level, and linking the digital token to the dataset occurs prior to transmitting the dataset and linked digital token to the distributed computing environment for processing.

5. The method of claim 1, wherein generating the digital token for the dataset further comprises generating multiple levels of metadata for the dataset related to processing of the dataset within the distributed computing environment using the decision-making logic, and incorporating the multiple levels of metadata into the digital token, the multiple levels of metadata including the one or more levels of metadata.

6. The method of claim 5, wherein generating the multiple levels of metadata comprises generating an immutable metadata level for the dataset, the immutable metadata level comprising one or more of dataset owning entity information, service level agreement (SLA) requirements for the dataset, privacy requirements for the dataset, confidentiality requirements for the dataset, export control requirements for the dataset, and notification criteria for the dataset when processed within the distributed computing environment, including by the distributed computing service.

7. The method of claim 5, wherein generating the multiple levels of metadata comprises generating a clone mutable metadata level for the dataset indicating that a token ID of the digital token is clone mutable during processing of the dataset within the distributed computing environment.

8. The method of claim 5, wherein generating the multiple levels of metadata comprises generating an append only metadata level for the dataset to indicate that one or more of: an error occurring during processing of the dataset within the distributed computing environment is to be appended to the metadata, and pedigree information is to be appended to the metadata during processing of the dataset within the distributed computing environment.

9. The method of claim 5, wherein generating the multiple levels of metadata further comprises generating a mutable metadata level for the dataset, the mutable metadata level to hold at least one of current location data of the dataset when being processed within the distributed computing environment, and classification data for the dataset when being processed within the distributed computing environment.

10. The method of claim 5, wherein generating the multiple levels of metadata comprises generating the multiple levels of metadata from the group consisting of an immutable metadata level, a clone mutable metadata level, an append only metadata level and a mutable metadata level for the dataset related to processing of the dataset within the distributed computing environment.

11. The method of claim 1, wherein generating the one or more levels of metadata for the dataset comprises generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment.

12. The method of claim 11, wherein incorporating the decision-making logic into the digital token comprises incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token.

13. A computer program product comprising:
one or more computer-readable storage media; and
program instructions stored on the one or more computer-readable storage media to perform operations comprising:
generating a digital token for a dataset to be processed by a distributed computing environment, the distributed computing environment including a distributed computing service, and generating the digital token comprising:
incorporating decision-making logic into the digital token to facilitate dataset processing within the distributed computing environment;
generating one or more levels of metadata for the dataset related to processing of the dataset within the distributed computing environment using the decision-making logic, and incorporating the one or more levels of metadata into the digital token;
linking the digital token to the dataset to facilitate control of processing of the dataset within the distributed computing environment, including by the distributed computing service; and
transmitting the dataset and linked digital token to the distributed computing environment for processing using, at least in part, the decision-making logic and the one or more levels of metadata of the digital token.

14. The computer program product of claim 13, wherein the decision-making logic of the digital token directs, with reference to the one or more levels of metadata, traversal of the dataset through the distributed computing service of the distributed computing environment during processing, and wherein generating the one or more levels of metadata comprises generating one or more of an immutable metadata level, a clone mutable metadata level, and an append only metadata level and a mutable metadata level for the dataset related to processing of the dataset within the distributed computing environment.

15. The computer program product of claim 13, wherein incorporating the decision-making logic into the digital token further comprises incorporating decision-making logic into the digital token for a status report call during processing of the dataset within the distributed computing environment, and wherein executing the status report call references, at least in part, the one or more levels of metadata incorporated into the digital token in sending a status report from the distributed computing environment to an identified computing system identified via the digital token, and wherein generating the one or more levels of metadata comprises generating one or more of an immutable metadata level, a clone mutable metadata level, an append only metadata level and a mutable metadata level for the dataset related to processing of the dataset within the distributed computing environment.

16. The computer program product of claim 13, wherein generating the digital token further comprises generating multiple levels of metadata for the dataset related to processing of the dataset within the distributed computing environment using the decision-making logic, and incorporating the multiple levels of metadata into the digital token, the multiple levels of metadata including the one or more levels of metadata, and wherein generating the multiple levels of metadata comprises generating the multiple levels of metadata from the group consisting of an immutable metadata level, a clone mutable metadata level, an append only metadata level and a mutable metadata level for the dataset related to processing of the dataset within the distributed computing environment.

17. The computer program product of claim 13, wherein generating the one or more levels of metadata for the dataset comprises generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment, and wherein incorporating the decision-making logic into the digital token comprises incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token.

18. A computer system comprising:
a processor set;
one or more computer-readable storage media; and
program instructions stored on the one or more computer-readable storage media to cause the processor set to perform operations comprising:
generating a digital token for a dataset to be processed by a distributed computing environment, the distributed computing environment including a distributed computing service, and generating the digital token comprising:
incorporating decision-making logic into the digital token to facilitate dataset processing within the distributed computing environment;
generating one or more levels of metadata for the dataset related to processing of the dataset within the distributed computing environment using the decision-making logic, and incorporating the one or more levels of metadata into the digital token;
linking the digital token to the dataset to facilitate control of processing of the dataset within the distributed computing environment, including by the distributed computing service; and
transmitting the dataset and linked digital token to the distributed computing environment for processing using, at least in part, the decision-making logic and the one or more levels of metadata of the digital token.

19. The computer system of claim 18, wherein the decision-making logic of the digital token directs, with reference to the one or more levels of metadata, traversal of the dataset through the distributed computing service of the distributed computing environment during processing, and wherein generating the one or more levels of metadata comprises generating one or more of an immutable metadata level, a clone mutable metadata level, an append only metadata level and a mutable metadata level for the dataset related to processing of the dataset within the distributed computing environment.

20. The computer system of claim 18, wherein generating the one or more levels of metadata for the dataset comprises generating a clone mutable metadata level indicating that a token ID of the digital token is clone mutable, and incorporating the clone mutable metadata level into the digital token to facilitate splitting of the dataset and cloning of the digital token during processing of the dataset within the distributed computing environment, and wherein incorporating the decision-making logic into the digital token comprises incorporating decision-making logic to spilt the dataset during processing within the distributed computing environment into disparate datasets, each with a clone of the digital token, and to assign a new unique token ID to each clone digital token and associated disparate dataset, pursuant to the token ID being clone mutable in the clone mutable metadata level incorporated within the digital token.

21. A method comprising:
generating a digital token for a dataset to be processed by a trusted machine learning environment which includes one or more distributed machine learning services, the generating of the digital token comprising:
incorporating decision-making logic into the digital token to facilitate dataset processing within the trusted machine learning environment, and to control how the dataset traverses the trusted machine learning environment during processing, including how the dataset traverses a distributed machine learning service of the one or more distributed machine learning services;
generating multiple levels of metadata for the dataset related to processing of the dataset within the trusted machine learning environment using the decision-making logic, and incorporating the multiple levels of metadata into the digital token, wherein the multiple levels of metadata include one or more of an immutable metadata level, a clone mutable metadata level, an append only metadata level, and a mutable metadata level for the dataset related to processing of the dataset within the trusted machine learning environment;
linking the digital token to the dataset to facilitate control of processing of the dataset within the trusted machine learning environment; and
transmitting the dataset and linked digital token to the trusted machine learning environment for processing using, at least in part, the decision-making logic and the multiple levels of metadata of the digital token.

22. The method of claim 21, wherein incorporating the decision-making logic into the digital token further comprises incorporating decision-making logic into the digital token for a status report call during processing of the dataset within the trusted machine learning environment, and wherein executing the status report call references, at least in part, one or more levels of metadata of the multiple levels of metadata incorporated into the digital token in sending a status report from the trusted machine learning environment to an identified computing system identified via the digital token.

23. The method of claim 21, wherein generating the multiple levels of metadata for the dataset comprises generating a clone mutable metadata level indicating that a token ID of the digital token is clone mutable, and incorporating the clone mutable metadata level into the digital token to facilitate splitting of the dataset and cloning of the digital token during processing of the dataset within the trusted machine learning environment, and wherein incorporating the decision-making logic into the digital token comprises incorporating decision-making logic to spilt the dataset during processing within the trusted machine learning environment into disparate datasets, each with a clone of the digital token, and to assign a new unique token ID to each clone digital token and associated disparate dataset, pursuant to the token ID being clone mutable in the clone mutable metadata level incorporated within the digital token.

24. A method comprising:
receiving, by a distributed computing environment with one or more distributed computing services, a dataset and a digital token linked to the dataset for processing within the distributed computing environment, the digital token comprising:
decision-making logic to facilitate processing of the dataset within the distributed computing environment; and
one or more levels of metadata for the dataset related to processing of the dataset within the distributed computing environment; and
processing the dataset within the distributed computing environment using, at least in part, the decision-making logic and the one or more levels of metadata of the received digital token linked to the dataset.

25. The method of claim 24, wherein the decision-making logic of the digital token directs, with reference to the one or more levels of metadata, traversal of the dataset through a distributed computing service of the one or more distributed computing services during processing of the dataset within the distributed computing environment.
